(19) United States
(12) Patent Application Publication
(10) Pub. No.: US 2025/0265687 A1
(43) Pub. Date: Aug. 21, 2025

(54) MODEL TRAINING METHOD AND PLATFORM, IMAGE INPAINTING METHOD AND APPARATUS, DEVICE, AND MEDIUM

(71) Applicant: BOE Technology Group Co., Ltd., Beijing (CN)

(72) Inventors: Dan Zhu, Beijing (CN); Qingqing Sun, Beijing (CN); Xiaotian Jiang, Beijing (CN)

(73) Assignee: BOE Technology Group Co., Ltd., Beijing (CN)

(21) Appl. No.: 18/703,045

(22) PCT Filed: Aug. 30, 2023
(86) PCT No.: PCT/CN2023/115646

§ 371 Date: Apr. 19, 2024

(51) Int. Cl. G06T 5/77; G06T 5/60; G06T 7/00

(52) U.S. Cl. CPC G06T 5/77; G06T 5/60; G06T 7/0002; G06T 2207/20081; G06T 2207/30168

(57) ABSTRACT

A model training method includes: acquiring a plurality of image sample pairs, where the image sample pair includes a first image sample and a second image sample of a same image, and image quality of the second image sample is higher than image quality of the first image sample; and training a first preset model with the plurality of image sample pairs as training samples, where the first preset model is configured to improve the image quality of the first image sample, and a process of the training includes: acquiring text data corresponding to a prediction image currently output by the first preset model, where the text data includes data for evaluating image quality of the prediction image; and updating parameters of the first preset model based on the text data, the prediction image, and the second image sample.

### FIELD

The present disclosure relates to the technical field of image processing, and in particular to a model training method and platform, an image inpainting method and apparatus, a device, and a medium.

### BACKGROUND

With the advancement of image processing technology, there is a need to in-paint images according to requirements, such as enhancing the images from low resolution to high resolution to improve image sharpness, inpainting scratches, noise, and other defects in the images to enhance image quality, and restoring missing parts in the images. In the related art, image inpainting is usually achieved by deep learning methods; however, the existing deep learning methods employ limited training mechanisms.

### SUMMARY

The present disclosure provides a model training method, including:
acquiring a plurality of image sample pairs, where the image sample pair includes a first image sample and a second image sample of a same image; and image quality of the second image sample is higher than image quality of the first image sample; and
training a first preset model with the plurality of image sample pairs as training samples, where the first preset model is configured to improve the image quality of the first image sample, and a process of the training includes:
acquiring text data corresponding to a prediction image currently output by the first preset model, where the text data includes data for evaluating image quality of the prediction image; and
updating parameters of the first preset model based on the text data, the prediction image, and the second image sample.

Exemplarily, the text data is the text input by the user with respect to the prediction image, the updating parameters of the first preset model based on the text data, the prediction image, and the second image sample includes:
determining a similarity between a target text and the prediction image, wherein the target text is the text data or a text with semantics opposite to that of the text data;
determining a loss value based on the prediction image and the second image sample; and
updating the parameters of the first preset model based on the similarity and the loss value.

Exemplarily, the determining a similarity between a target text and the prediction image includes:
encoding the target text to obtain a text feature vector of the target text;
encoding the prediction image to obtain an image feature vector of the prediction image, wherein the text feature vector and the image feature vector have a consistent dimension; and
determining the similarity based on the text feature vector and the image feature vector.

In an embodiment, the training a first preset model with the plurality of image sample pairs as training samples includes:
performing first training on the first preset model with part of the image sample pairs as training samples, wherein in the first training, the parameters of the first preset model are updated based on the prediction image output by the first preset model and the second image sample; and
performing second training on a first preset model obtained by the first training with part of or all the image sample pairs as training samples, wherein
in the second training, parameters of the first preset model obtained by the first training are updated based on the text data, the prediction image, and the second image sample.

Exemplarily, the method further including:
acquiring a plurality of third image samples and text data samples corresponding to the third image samples, wherein the text data sample is used for describing image quality of the third image sample;
performing third training on a second preset model based on the plurality of third image samples and the text data samples, wherein the second preset model is configured to determine a similarity between the third image sample and the text data sample; and
the updating parameters of the first preset model based on the text data, the prediction image, and the second image sample including:
inputting the prediction image and the text data into a second preset model after completion of the third training; and
updating the parameters of the first preset model based on the similarity output by the second preset model, the prediction image, and the second image sample.

Exemplarily, the text data sample carries a class label, the class label is used for indicating whether a description of the text data sample conforms to the image quality of the third image sample; the performing third training on a second preset model based on the plurality of third image samples and at least two corresponding text data samples includes:
inputting the third image samples and the text data samples into the second preset model to obtain a prediction similarity between the third image sample and each text data sample; and
updating parameters of the second preset model based on the prediction similarity and the class label.

Exemplarily, the third image sample corresponds to a text data sample of a first class and a text data sample of a second class; the first class characterizes that a description of the text data sample conforms to the image quality of the third image sample, and the second class characterizes that the description of the text data sample does not conform to the image quality of the third image sample.

Exemplarily, the second preset model includes a text encoder and an image encoder, and a similarity determination module connected to the text encoder and the image encoder, wherein,
the text encoder is configured to perform text encoding on the text data sample to obtain a prediction text vector;
the image encoder is configured to perform image encoding on the third image sample to obtain a prediction image vector, wherein the prediction image vector and the prediction text vector have a consistent dimension; and
the similarity determination module is configured to determine a prediction similarity between the prediction image vector and the prediction text vector.

Exemplarily, steps of the performing third training on the second preset model is performed in training the first preset model; the plurality of third image samples include at least one of the following: the first image sample, the second image sample, and a prediction image output by the first preset model before a current moment.

Exemplarily, the third training is performed during an interval in training the first preset model; the third image sample includes a prediction image output by the first preset model for the first image sample; and the performing third training on a second preset model based on the plurality of third image samples and the text data samples includes:
inputting a plurality of first image samples into the first preset model; and
inputting the prediction image output by the first preset model and a text data sample corresponding to the prediction image into the second preset model to perform the third training on the second preset model, wherein
in the third training, the parameters of the first preset model are fixed.

Exemplarily, after the third training, the training a first preset model includes:
inputting a plurality of first image samples into the first preset model;
inputting the prediction image output by the first preset model and the text data into the second preset model; and
updating the parameters of the first preset model based on the prediction image, the second image sample, and the prediction similarity output by the second preset model,
wherein the parameters of the second preset model are fixed in updating the parameters of the first preset model.

Exemplarily, the acquiring a plurality of third image samples and text data samples corresponding to the third image samples includes:
acquiring first text data corresponding to the third image samples;
determining a class corresponding to the first text data, the class being used for indicating whether a description of the first text data conforms to the image quality of the third image sample;
generating second text data based on the first text data, wherein a class of the second text data is different from the class of the first text data; and
using the first text data and the second text data as the text data samples corresponding to the third image samples.

Exemplarily, the acquiring text data corresponding to a prediction image currently output by the first preset model includes:
determining whether a target third image sample corresponding to the prediction image exists from the plurality of third image samples, wherein the target third image sample and the prediction image correspond to the same first image sample;
if yes, using a text data sample corresponding to the target third image sample as the text data; and
if no, acquiring text data input for the prediction image.

Exemplarily, the acquiring text data corresponding to a prediction image currently output by the first preset model includes:
displaying the prediction image; and
acquiring text data input for the prediction image.

Exemplarily, after the displaying the prediction image, the method further includes:
monitoring an input operation on an operation interface displaying the prediction image; and
using, in response to the input operation being not monitored, preset text data as the text data corresponding to the prediction image; and
the acquiring text data input for the prediction image includes:
acquiring, in response to the input operation being monitored, the text data input for the prediction image.

Exemplarily, the text data includes at least one entry; the at least one entry is used for describing image quality of the prediction image in different image regions and/or different quality dimensions.

Exemplarily, the method further includes at least one of the following:
displaying the prediction image output by the first preset model in response to the first training, and ending the first training in response to a first preset operation performed on the prediction image; and
displaying the prediction image output by the first preset model in response to the second training, and ending the second training in response to a second preset operation performed on the prediction image.

Exemplarily, in performing the third training on the second preset model, further including:
displaying a loss value corresponding to at least one training of the second preset model before a current moment, wherein a gradient is determined by the prediction similarity and the class label; and
ending the third training in response to a third preset operation performed on each loss value displayed.

The present disclosure further discloses an image inpainting method, including:
acquiring a target image to be in-painted;
inputting the target image into an image inpainting model, wherein the image inpainting model is a first preset model trained by the model training method; and
acquiring an in-painted image output by the image inpainting model, wherein image quality of the in-painted image is higher than that of the target image.

The present disclosure further discloses a model training platform, including:
a sample library, configured to store a plurality of image sample pairs, wherein the image sample pair includes a first image sample and a second image sample of a same image; and image quality of the second image sample is higher than image quality of the first image sample; and
a training module, configured to perform a plurality of training on a first preset model with the plurality of image sample pairs as training samples, wherein the first preset model is configured to improve the image quality of the first image sample, and a process of the training includes:
acquiring text data corresponding to a prediction image currently output by the first preset model, wherein the text data includes data for evaluating image quality of the prediction image; and
updating parameters of the first preset model based on the text data, the prediction image, and the second image sample.

The present disclosure further discloses an image inpainting apparatus, including:
a first acquisition module, configured to acquire a target image to be repaired;
an input module, configured to input the target image into an image inpainting model, wherein the image inpainting model is a first preset model trained by the model training method; and
a second acquisition module, configured to acquire an in-painted image output by the image inpainting model, wherein image quality of the in-painted image is higher than that of the target image.

The present disclosure provides a model training method, which can acquire a plurality of image sample pairs, and train a first preset model with the plurality of image sample pairs as training samples, where the training process includes: acquiring text data corresponding to a prediction image currently output by the first preset model; updating parameters of the first preset model based on the text data, the prediction image, and the second image sample. Specifically, the image sample pair includes a first image sample with a low quality and a second image sample with a high quality of the same image; accordingly, the first preset model is used for improving the image quality of the first image sample.

The training method provided by the present disclosure is used, in the process of training the first preset model using a plurality of image sample pairs, the parameters of the first preset model can be updated using the text data, the prediction image, and the second image sample; since the text data includes data for evaluating the image quality of the prediction image, namely, the text data can be used for evaluating the image quality of the prediction image so that the training can be supervised not only based on the difference between the prediction image output by the model and the second image sample but also the text data for evaluating the prediction image can be acquired to supervise the training according to the image quality evaluation provided by the text data. In this way, the model training can be supervised from the pixel difference dimension between the prediction image and the second image sample and the quality assessment dimension for the prediction image, so that the model can be combined with the provided quality assessment to provide a direction for model optimization via the text data, thereby optimizing the model effect and improving the image inpainting quality of the trained model.

The embodiments of the present disclosure disclose an electronic device, including a memory, a processor, and computer programs stored on the memory and executable on the processor; the processor, when executed, implements the model training method or the image inpainting method as described.

The embodiments of the present disclosure further disclose a computer-readable storage medium storing computer programs that cause a processor to execute the model training method or the image inpainting method as described in the present disclosure.

The above description is only an overview of the technical solution of the present disclosure. To understand the technical means of the present disclosure more clearly, it can be implemented following the contents of the specifications; and to make the above and other purposes, features, and advantages of the present disclosure obvious and easy to understand, the following are the specific implementation of the present disclosure.

### BRIEF DESCRIPTION OF THE DRAWINGS

FIG. 1 shows an overall flow diagram of a model training method in an embodiment of the present disclosure;

FIG. 2 shows a step flow diagram of a model training method in an embodiment of the present disclosure;

FIG. 3 shows a process diagram of training a first preset model in stages in an embodiment of the present disclosure;

FIG. 4 shows a process diagram of a training stage in which a second preset model is added during the training of a first preset model in an embodiment of the present disclosure;

FIG. 5 shows a step flow diagram of training a second preset model in an embodiment of the present disclosure;

FIG. 6 shows a configuration diagram of a third image sample input to a second preset model in an embodiment of the present disclosure;

FIG. 7 shows an acquisition process diagram of a text data sample corresponding to a third image sample in an embodiment of the present disclosure;

FIG. 8 shows a model structure diagram of a second preset model in an embodiment of the present disclosure;

FIG. 9 shows a complete process diagram of a first training, a second training, and a third training in an embodiment of the present disclosure;

FIG. 10 shows another process diagram of training a second preset model in an embodiment of the present disclosure;

FIG. 11 shows a loss value variation trend graph of a second preset model during third training in an embodiment of the present disclosure;

FIG. 12 shows a process diagram of a model training method in an embodiment of the present disclosure;

FIG. 13 shows a frame structural diagram of a model training platform in an embodiment of the present disclosure;

FIG. 14a shows a diagram of a first operation interface of a model training platform during execution of model training in an embodiment of the present disclosure;

FIG. 14b shows a diagram of a second operation interface of a model training platform during execution of model training in an embodiment of the present disclosure;

FIG. 14c shows a diagram of a third operation interface of a model training platform during execution of model training in an embodiment of the present disclosure;

FIG. 14d shows a diagram of a fourth operation interface of a model training platform during execution of model training in an embodiment of the present disclosure;

FIG. 15 shows a step flow diagram of an image inpainting method in an embodiment of the present disclosure; and

FIG. 16 shows a frame structure diagram of an image inpainting apparatus in an embodiment of the present disclosure.

### DETAILED DESCRIPTION

To make the purpose, technical solution, and advantages of this disclosed implementation example clearer, the following will combine the figures in this disclosed implementation example to provide a clear and complete description of the technical solution in this disclosed implementation example. It is apparent that the described embodiments are part of this disclosure and not all embodiments. Based on the embodiments disclosed herein, all other embodiments obtained by those skilled in the art in the absence of creative effort are within the scope of protection of this disclosure.

In the related art, image inpainting is usually realized by a deep learning method, such as obtaining an image inpainting model by training self-encoding fully convolutional networks (FCN) or generative adversarial networks; however, the training effect of the model is mostly adjusted and improved through neural network structure design, loss function, training parameters, and the like, which makes it difficult to greatly improve the quality of the trained model to in-paint the image.

Given this, the training process of the model is improved. Specifically, human quality feedback language for image inpainting is incorporated into the model training process, so that during the training process, the model can not only use the pixel difference between the network-in-painted image and the complete image to supervise the training but also use human quality feedback language for image inpainting, to supervise the training in combination with the quality feedback language. In this way, the model can perceive human visual evaluation through the evaluation language of the network-in-painted image during the training process, assisting the model in updating the parameters, to optimize the training effect of the model and help improve the quality of the image in-painted by the model.

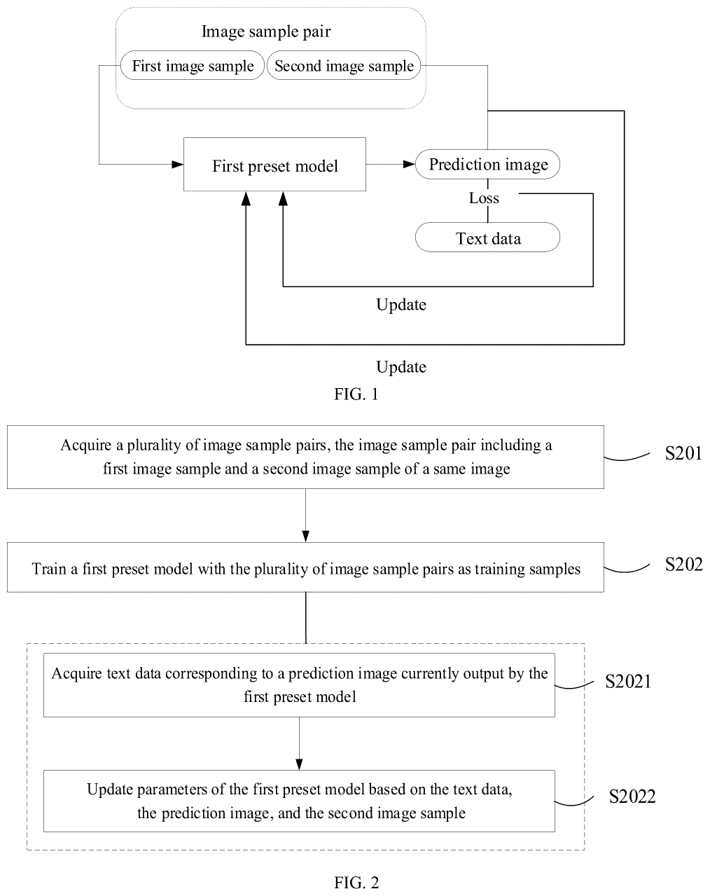

Referring to FIGS. 1 and 2, FIG. 1 shows an overall flow diagram of a model training method of the present disclosure, and FIG. 2 shows a step flow diagram of a model training method of the present disclosure. As shown in FIGS. 1 and 2, the model training method of the present disclosure can be applied to an electronic device, and specifically can include the following steps:

S201: acquire a plurality of image sample pairs, the image sample pair including a first image sample and a second image sample of a same image.

The image quality of the second image sample is higher than the image quality of the first image sample.

In the embodiment, since the image sample pair includes the first image sample and the second image sample with different image qualities of the same image, the image contents included in the first image sample and the second image sample are the same, only the image qualities are different. The image quality can include an image quality description such as a resolution, noise, and scratch. Exemplarily, the image quality of the second image sample being higher than the image quality of the first image sample can include: the resolution of the second image sample is higher than the resolution of the first image sample, or the noise of the second image sample is less than the noise of the first image sample; alternatively, the second image sample has no scratches and the first image sample has scratches.

Exemplarily, two images with different image qualities can be collected for the same scene at the same view angle, for example, a low-resolution image and a high-resolution image are taken for the same person so that the low-resolution image is taken as a first image sample and the high-resolution image is taken as a second image sample. Exemplarily, a piece of high-definition (HD) image may be blurred, and the blurred image is taken as a first image sample, and the HD image is taken as a second image sample. Exemplarily, a piece of HD image may be processed by scratches, noise, and the like, so that the image of scratches and noise is taken as a first image sample, and the HD image is taken as a second image sample.

Exemplarily, when an application scene is a scene in-painted by an old photograph, the object of model training is to obtain a model that can in-paint the old photograph, and the model needs to improve the resolution of the old photograph and in-paint a missing part in the old photograph; when acquiring a plurality of image sample pairs, a low-resolution image, and a high-resolution image can be taken for the same person, the low-resolution image is taken as a first image sample and the high-resolution image is taken as a second image sample; a high-resolution image is taken for the same person, the high-resolution image is blurred, following by adding corresponding noise and scratches and randomly picking up a partial region to obtain a first image sample, and taking the high-resolution image as a second image sample.

The sizes of the first image sample and the second image sample can be processed to preset sizes to satisfy the model training requirements.

S202: Train a first preset model with the plurality of image sample pairs as training samples, where the first preset model is configured to improve the image quality of the first image sample.

After obtaining a plurality of image sample pairs, a plurality of first image samples in the plurality of image sample pairs can be taken as an input of the first preset model, and a second image sample can be taken as a supervision of the model, to train the first preset model; the first preset model may adopt an existing model structure, which will not be described in detail herein.

The first preset model is mainly configured to perform image inpainting on the input first image sample to improve the image quality of the first image sample, and specifically, the image inpainting can mainly include sharpness inpainting, scratch inpainting, and noise elimination; sharpness inpainting may refer to improving the resolution of a first image sample; of course, in addition to the image inpainting in the above-mentioned example, other types of inpainting may also be included, such as the restoration of the missing part of the image. In practice, the first preset model may be used for performing at least one of the above-mentioned image inpainting, namely, performing at least one of the inpainting processing of sharpness inpainting, scratch inpainting, noise elimination, and restoration of missing parts.

The first preset model obtains an in-painted prediction image after performing image inpainting on the first image sample, and the first preset model outputs the prediction image, and a gap between the prediction image and the second image sample can be used for supervising the training of the first preset model, such as for updating parameters of the first preset model.

In the process of training the first preset model, at least in one training, text data of an image quality evaluation performed by a user on a prediction image output by the first preset model is acquired, and then, based on the text data, a gap between the prediction image and an expected image quality level (an image quality level represented by a second image sample) is determined, and the gap is used, together with the above-mentioned gap between the prediction image and the second image sample for supervising the training of the first preset model.

Accordingly, in the process of training the first preset model, at least in one training, the following steps are performed:

S2021: Acquire text data corresponding to a prediction image currently output by the first preset model.

S2022: Update parameters of the first preset model based on the text data, the prediction image, and the second image sample.

The text data includes data for evaluating image quality of the prediction image.

In the embodiment, in one training, a prediction image can be displayed, for example, a prediction image output by a first preset model is displayed on a display interface of an electronic device, so that a user can visually observe the inpainting effect of the first preset model on the first image sample, and thus text for image quality evaluation of the prediction image can be input for the prediction image, and text data corresponding to the prediction image can be obtained.

The user can input text data via an input tool, such as typing text data on an input interface; alternatively, the voice of the user can be collected by the voice collection module, and then the voice can be recognized to obtain the text data, in which case the user can speak the quality evaluation language for the prediction image to the voice collection module without manual input by the user.

The text data may include a sentence for evaluating the prediction image, for example, the text data includes a sentence of “the image is not clear enough”, and when the parameters of the first preset model are updated in combination with the text data, the first preset model needs to be optimized in the direction of “the image is clearer”; for another example, if the text data includes a sentence of “hair is unclear”, when the parameters of the first preset model are updated in combination with the text data, the first preset model needs to be optimized in the direction of “hair is clearer”; for another example, if the text data includes a sentence of “image noise is not eliminated cleanly”, when the parameters of the first preset model are updated in combination with the text data, the first preset model needs to be optimized in the direction of “eliminating the noise cleanly”.

In practice, when the parameters of the first preset model are updated according to the text data, the prediction image, and the second image sample, since the text data can characterize the image quality gap between the prediction image and the second image sample, the first gap between the prediction image and the second image sample at the user perspective level can be determined according to the text data and the prediction image, and the second gap between the prediction image and the second image sample at the pixel level can be determined according to the prediction image and the second image sample; then, when updating the parameters of the first preset model, it can be performed according to the first gap and the second gap, so that the first preset model can be optimized not only towards the optimization direction provided by the user's vision, but also towards the optimization direction provided by the second image sample, so that the first preset model can be combined with the provided quality assessment to acquire the ability to perceive human vision, thereby providing multiple optimization directions for the first preset model, improving the model training method in the field of image inpainting, and helping to improve the image inpainting quality of the first preset model.

In some embodiments, the text data may include at least one entry; the at least one entry is used for describing the image quality of the prediction image in different image regions and/or different quality dimensions.

In the embodiment, the text data may include at least one entry, which may differ depending on the image inpainting task to be performed by the first preset model, that is, the at least one entry corresponds to the image inpainting task. Specifically, it may include image quality for describing different image regions and/or different quality dimensions.

The image regions refer to different regions in a prediction image; in image inpainting, for the same image inpainting task, the inpainting effects of different image regions may have differences, and then the differences of different image regions in the inpainting can be indicated through text data.

Exemplarily, in old photo inpainting, for sharpness inpainting, it is necessary to perform sharpness inpainting on the faces of two people at the same time; the face of one person is more clearly in-painted, while the face of the other person is less clearly in-painted; as another example, for sharpness inpainting, when it is necessary to simultaneously perform sharpness inpainting on a person's face and perform sharpness inpainting on the person's clothing accessories, there may be cases where the person's face is more clearly in-painted and the clothing accessories are less clearly in-painted. Accordingly, the text data includes an image quality evaluation of the prediction image in different image regions, for example, the entries related to an image region in the text data may include that clothing accessories are not clear enough, face A is not clear enough, and the like.

The quality dimension is related to the image inpainting task executed by the first preset model, and an image inpainting task may correspond to a quality dimension, for example, if the image inpainting task is a sharpness inpainting task, the quality dimension includes a sharpness dimension, and if the image inpainting task further includes a scratch inpainting task, then the quality dimension further includes a scratch dimension.

Exemplarily, the image inpainting task of the first preset model includes sharpness inpainting and scratch inpainting, and then the entry relating to the quality dimension in the text data may include at least one of insufficient clarity of the image and existence of scratches; exemplarily, if the image inpainting task of the first preset model includes sharpness inpainting and noise elimination, the entry included in the text data may include at least one of insufficient clarity of the image and existence of noise; exemplarily, if the image inpainting task of the first preset model includes noise elimination and restoration of missing parts, then the entry included in the text data may include at least one of existence of noise and incomplete restoration of missing parts; exemplarily, if the image inpainting task of the first preset model includes sharpness inpainting and restoration of missing parts, then the entry included in the text data may include at least one of insufficient clarity and incomplete restoration of missing parts.

Of course, the above is merely illustrative, and in other examples, other image inpainting tasks may be included, and the text data may include entries describing prediction images in other quality dimensions.

When the above-mentioned method is used, the text data can indicate a weak link of the first preset model in the process of image inpainting, and thus when updating the first preset model, a region to be optimized having a difference from an expected image quality in a prediction image can be determined via the text data, so that the region to be optimized can be fed back to the first preset model, and the first preset model is supervised to strengthen learning on the inpainting of the region to be optimized, thereby guiding the first preset model to perform continuous optimization on the weak link of the image inpainting.

In some embodiments, since the text data is used for evaluating the image quality of the prediction image, the text data may include the text of a reverse evaluation prediction image; the reverse evaluation prediction image refers to the evaluation that the contained text is opposite to the real image quality of the prediction image, and if the face in the prediction image is unclear, the reverse evaluation is clear face; as another example, if there is a scratch in the prediction image, the reverse evaluation is no scratches.

Alternatively, the text data may include the text of a positive evaluation prediction image; the positive evaluation prediction image refers to an evaluation that the contained text is consistent with the real image quality of the prediction image, and if the face in the prediction image is unclear, the positive evaluation is unclear face; as another example, if there is a scratch in the prediction image, the positive evaluation is that scratches are present.

Since the parameters of the first preset model can be updated in combination with the text data, it is necessary to enable the first preset model to determine the weak link in the image inpainting process in combination with the text data during the training process, which can be understood as the need to determine the optimization direction of the model in the image inpainting process in combination with the text data; thus, the text data, whether positive evaluation or reverse evaluation, can indicate in which direction the model needs to be optimized. Specifically, based on the text data, it is possible to determine where the image quality of the prediction image needs to be improved.

In the embodiment, a gap between the prediction image and an expected image quality level (which can be understood to be an image quality level represented by the second image sample) can be determined based on the text data; the gap reflects the evaluation of the prediction image from the human perspective so that the first preset model perceives the evaluation of the human perspective through the text data; in the process of updating the parameters of the first prediction model, it can be performed based on the gap and the gap in pixels between the prediction image and the second image sample.

Since the text data can be data generated by positive evaluation or data generated by reverse evaluation, and since it is necessary to guide the first preset model to be optimized towards an expected image quality level based on the text data, a gap between the prediction image and the text data for reverse evaluation can be determined, and the gap can be characterized by the similarity between the text data for reverse evaluation and the prediction image.

In a specific implementation, the similarity between the target text and the prediction image can be determined, and the loss value can be determined based on the prediction image and the second image sample; the parameters of the first preset model may then be updated based on the similarity and the loss value. The target text is the text data or a text with semantics opposite to that of the text data.

The target text contains a desired description of the image quality for which the prediction image needs to be further optimized; exemplarily, if the background of the prediction image is not clear enough, the target text needs to contain a desired description of “clear background” to clarify the optimization direction for optimizing the image inpainting.

In one implementation, if the text data is data generated by positive evaluation, a text with semantics opposite to that of the text data can be determined, and then the text data of positive evaluation is converted into the text data of reverse evaluation, so that the text data of reverse evaluation obtained after conversion can be taken as a target text, and the similarity between the target text and the prediction image can be determined; exemplarily, if the hair of the portrait in the prediction image is not clear enough and the text data contains a positive description of “hair is not clear”, the “hair is not clear” needs to be converted to “hair is clear” to clarify the optimization direction for optimizing the image inpainting.

If the text data is data generated by reverse evaluation, the text data can be used as target text to determine the similarity between the target text and the prediction image.

In the implementation, when the parameters of the first preset model are updated, it is also required to perform according to the difference in pixels between the prediction image and the second image; specifically, a loss value can be determined according to the prediction image and the second image sample; specifically, a loss function can be constructed according to the prediction image and the second image sample to obtain a loss value; the loss function can use the loss function shown in the following formula (1) or formula (2):

$$Loss 1 = \frac{1}{C \times H \times W} {\sum }_{c = 1}^{C} {\sum }_{i = 1}^{H} {\sum }_{j = 1}^{W} \vert {y}_{i , j , c} - f ( {x}_{i , j , c} ) \vert \qquad Formula ( 1 )$$

$$Loss 2 = \frac{1}{C \times H \times W} {\sum }_{c = 1}^{C} {\sum }_{i = 1}^{H} {\sum }_{j = 1}^{W} {( {y}_{i , j , c} - f ( {x}_{i , j , c} ) )}^{2} \qquad Formula ( 2 )$$

In the above formula (1) and formula (2), C represents the number of channels (if the RGB image has 3 channels, then C=3, and if the grayscale image has a single channel, then C=1); H represents the height of the image; and W represents the width of the image. y is the truth image; x is the input image; and f(x) is the output image.

Since the similarity can reflect the difference between the prediction image and the expected image quality, the value thereof can be 0 to 1, and the loss value can reflect the gap between the prediction image and the second image sample, and the value thereof can also be 0 to 1; and in practice, the similarity can also be considered as a type of loss value, and then the parameters of the first preset model can be updated according to the two kinds of loss values. Specifically, weights may be preset for the similarity and the loss value, the two are weighted and summed according to the weights to obtain a total loss, and the parameters of the first preset model are updated based on the total loss.

In one example, the weight corresponding to the similarity may be less than the weight corresponding to the loss value, that is, the importance of the first gap on the user perspective level of the prediction image determined based on the text data may be slightly less than the importance of the second gap on the pixel level between the prediction image and the second image sample.

Since the text data is text type data and the prediction image is image type data, when determining the similarity between the two, the two can be converted into the same feature space for comparison, namely, converting the text data into target type data, and converting the prediction image into target type data, so that the similarity between the two converted into target type data can be determined.

Exemplarily, a prediction image can be converted into text type data, so that the prediction image can be compared with the text data in the same text space; and specifically, feature extraction can be performed on the prediction image to obtain an feature vector; and then the feature vector is converted into a text vector according to a certain rule, so that a comparison can be made with the text data.

Exemplarily, in the embodiment, in determining the similarity between the target text and the prediction image, the two may be encoded first to obtain vectors each of which is obtained after encoding, thereby determining the similarity based on the distance between the vectors. Specifically, the target text can be encoded to obtain a text feature vector of the target text, and the prediction image can be encoded to obtain an image feature vector of the prediction image; then, the similarity is determined based on the text feature vector and the image feature vector;

The text feature vector and the image feature vector have a consistent dimension.

In the embodiment, when encoding the target text, the keywords in the target text can be encoded, and the text feature vector obtained by encoding can be a one-dimensional vector; when encoding the prediction image, feature extraction can be performed on the prediction image first, then the extracted image features are encoded, and a one-dimensional image feature vector can also be obtained after encoding; then, the cosine distance between the text feature vector and the image feature vector can be calculated to obtain the similarity between the two. Next, the training process of the first preset model is described.

In some examples, the first preset model can be trained in stages; in the process of training the first preset model in stages, two stages can be included; in the first stage, the first preset model can be firstly trained using part of image sample pairs, and this training process may not add text data; after the training in this stage is completed, the second stage is entered; in the second stage, the training of the first preset model can be continued with the remaining image sample pairs, during which stage text data can be added for parameter updating.

Referring to FIG. 3, a process diagram of training a first preset model in stages is shown, and as shown in FIG. 3, the first training is performed on the first preset model with part of the image sample pairs as training samples; and the second training is performed on the first preset model obtained by the first training with part of the image sample pairs as training samples.

In the first training, the parameters of the first preset model are updated based on the prediction image output by the first preset model and the second image sample; in the second training, the parameters of the first preset model obtained by the first training are updated based on the text data, the prediction image, and the second image sample.

The part of the image sample pairs used in the first training and the part of the image sample pairs used in the second training can be an image sample pair without cross repetition; exemplarily, n first image sample pairs of the plurality of image sample pairs are used in the first training, and the m image sample pairs used in the second training may be second image sample pairs of the plurality of image sample pairs exclusive of the n first image samples.

In still other examples, there may be repeated image sample pairs between the image sample pair used in the first training and the image sample pair used in the second training; exemplarily, n first image sample pairs of the plurality of image sample pairs are used in the first training; the plurality of image sample pairs may be all used in the second training, or may be part of m second image sample pairs, the m second image sample pairs including at least one first image sample pair. In this case, since the image sample pairs used in the first training and the second training is not repeated, the diversity of training samples can be improved, thereby improving the generalization performance of the first preset model.

The prediction images output by the first preset model in the second training and the first training can be displayed, when there are repeated image samples between the image sample pair used in the first training and the image sample pair used in the second training, both the prediction images corresponding to the same first image sample in the first training and the prediction images corresponding to the same first image sample in the second training can be displayed, to facilitate a user in determining whether the same image is subjected to an optimal inpainting in the second training.

For example, when a prediction image corresponding to a first image sample is output in a second training, it can be determined whether the first image sample is input to a first preset model in the first training, and if yes, the prediction image corresponding to the first image sample in the first training is output together, and thus the prediction images corresponding to the first image sample in the first training and the second training can be displayed simultaneously on a display interface, to determine whether the first preset model is optimized in the second training by comparing two prediction images.

In the first training, since there is no need to add text data for supervision, it can be understood a pre-training on the first preset model, and the first training can be stopped when the pre-training satisfies the end condition. The end condition may refer to the difference between the prediction image and the second image sample being small, for example, the loss value is less than a preset loss threshold, of course, to achieve that the first training can be completed as soon as possible to reach the goal of pre-training, the loss threshold can be set to be larger, for example, to reach the basic image inpainting capability, and the first training can be ended.

The ending condition can also be triggered by the user; as stated above, during the first training, the first preset model can output a prediction image corresponding to the first image sample, and then the user can determine the image inpainting capability of the first preset model via the prediction image, and thus the user can decide when to end the first training.

In still other embodiments, since it is necessary to determine, based on text data, a gap between the prediction image and an expected image quality level (an image quality level represented by the second image sample); in practice, it is necessary to determine the similarity between the target text and the prediction image, and in some examples, the similarity between the target text and the prediction image can be determined through a neural network, that is, using a deep learning technique to train a second preset model so that the second preset model can acquire a text feature vector of the target text and an image feature vector of the prediction image; the similarity between the target text and the prediction image is determined.

Specifically, in the process of training the first preset model in stages, a stage of training the second preset model may also be included. The second preset model may be a contrastive language-image pre-training (CLIP) model structure, which may include an image encoder for encoding the prediction image and a text encoder for encoding the text data.

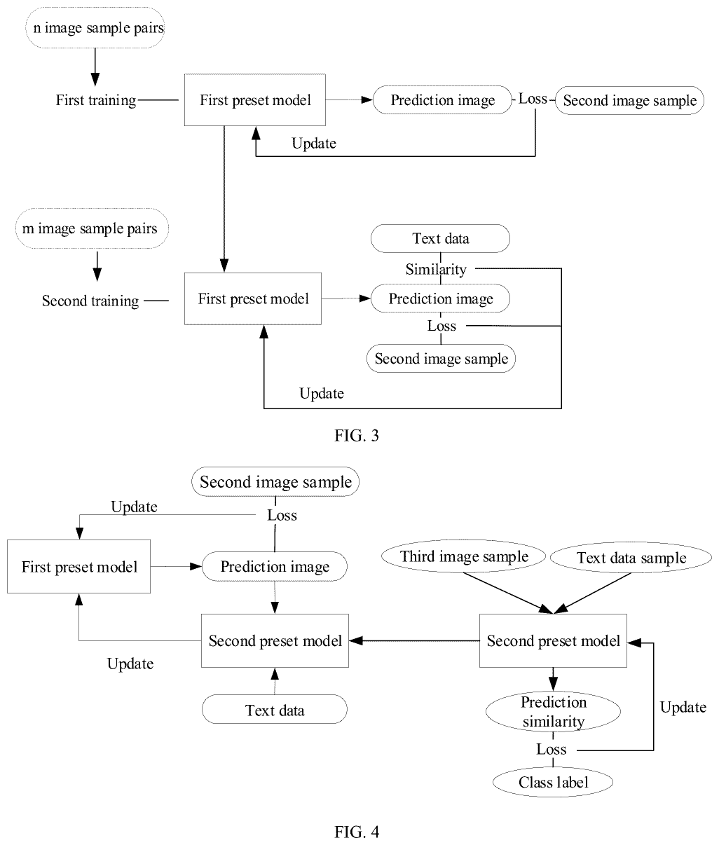

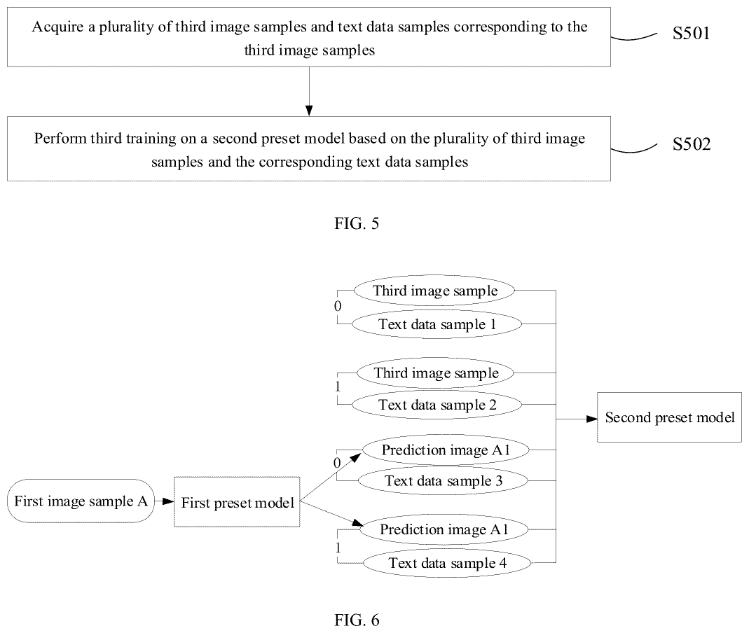

Referring to FIGS. 4 and 5, FIG. 4 shows a process diagram of a training stage in which a second preset model is added during the training of the first preset model, and FIG. 5 shows a step flow diagram of training a second preset model. As shown in FIGS. 4 and 5, before the first training or before the second training of the first preset model, the following steps can also be included:

S501: Acquire a plurality of third image samples and text data samples corresponding to the third image samples.

S502: Perform third training on the second preset model based on the plurality of third image samples and the corresponding text data samples.

The second preset model when the third training is completed is configured to determine the similarity between the prediction image and the text data in the training of the first preset model.

Accordingly, as shown in FIG. 4, when the parameters of the first preset model are updated based on the text data, the prediction image, and the second image sample, the prediction image and the text data can be input to the second preset model when the third training is completed; and the parameters of the first preset model may be updated based on the similarity output by the second preset model, the prediction image, and the second image sample.

In the embodiment, the third image sample may be different from the image sample pair described above, or may include an image sample of the image sample pair described above, or may include the prediction image output during the first training. In practice, it may not be required to have a connection between the third image sample and the above-mentioned image sample pair, for example, the image sample pair is a portrait photograph, and the third image sample may not be limited to a portrait photograph, but may also be an image of an animal, thereby reducing the difficulty of obtaining the image sample.

Each third image sample corresponds to a text data sample, and as stated above, the text data may include text data generated by performing positive evaluation on the prediction image and text data generated by performing reverse evaluation on the prediction image, and in some examples, in the third training, the text data sample corresponding to the third image sample may be data generated by performing positive evaluation on the third image sample, or data generated by performing reverse evaluation on the third image sample, or the third image sample may also be two text data samples generated by performing positive and reverse evaluations.

The text data sample may also include at least one entry; at least one entry is used for describing the image quality of the third image sample in different image regions and/or the image quality in different quality dimensions.

In this case, when labeling a text data sample corresponding to a third image sample, the labeling can be performed according to the image inpainting task of the first preset model, for example, the image inpainting task is a sharpness inpainting task, and then the entry of the labeled text data sample in the quality dimension can include entry of the sharpness dimension, such as whether each image region is clear.

Taking the positive evaluation as an example, the image inpainting task of the first preset model includes sharpness inpainting and noise elimination; if the image quality of the third image sample is not high (insufficient clarity, existence of noise, existence of scratches, or non-restoration of partial regions), the entry included in the text data sample may include at least one of insufficient clarity of the image and existence of noise; for example, if the image inpainting task of the first preset model includes noise elimination and restoration of missing parts, then the entry included in the text data sample may include at least one of the existence of noise and incomplete restoration of missing parts; for another example, if the image inpainting task of the first preset model includes sharpness inpainting and restoration of missing parts, then the entry included in the text data sample may include at least one of insufficient clarity and incomplete restoration of missing parts.

Taking reverse evaluation as an example, the image inpainting task of the first preset model includes sharpness inpainting and noise elimination; if the image quality of the third image sample is not high (insufficient clarity, existence of noise, existence of scratches, or non-restoration of partial regions), the entry included in the text data sample may include at least one of sufficient clarity of the image and inexistence of noise; for example, if the image inpainting task of the first preset model includes noise elimination and restoration of missing parts, then the entry included in the text data sample may include at least one of the inexistence of noise and complete restoration of missing parts; for another example, if the image inpainting task of the first preset model includes sharpness inpainting and restoration of missing parts, then the entry included in the text data sample may include at least one of sufficient clarity and complete restoration of missing parts.

The image region refers to different regions in the third image sample, and the entry related to the image region in the text data sample thereof may also be related to the image inpainting task to be performed by the first preset model.

Taking the positive evaluation as an example, for the sharpness inpainting task, the third image sample may include a plurality of different image regions, and if the third image sample is not sufficiently clear in the image region 1 and the image region 2, the text data sample may include entries such as insufficient clarity of image region 1 (such as clothing accessories), and insufficient clarity of image region 2 (such as face A).

Taking the reverse evaluation as an example, for the sharpness inpainting task, the third image sample may include a plurality of different image regions, and if the third image sample is not sufficiently clear in image region 1 and image region 2, the text data sample may include entries such as sufficient clarity of image region 1 (such as clothing accessories) and sufficient clarity of image region 2 (such as face A).

Adopting such a labeling manner of the text data sample, the text data sample labeled by the third image sample is related to the image inpainting task of the first preset model so that the second preset model can be optimized towards a similarity determination manner required by the image inpainting task of the first preset model in the third training, and then the second preset model can extract an image feature vector of the third image sample and a text feature vector of the text data sample towards the direction related to the image inpainting task, for example, the feature reflecting the text and the image on the image inpainting task is fully extracted as an optimization direction, and the optimization of the second preset model is performed. This allows the second preset model to match the needs of the first preset model, thereby providing the first preset model with a more accurate comparison between the prediction image and the text data.

In some embodiments, in the third training, the second preset model needs to be subjected to third training based on a plurality of third image samples and text data samples, and since the second preset model is used for determining the similarity between the third image samples and the text data samples, the parameters of the second preset model can be updated based on the similarity output by the second preset model and the true similarity between the third image samples and the text data samples. As shown in FIG. 4, specifically, the text data sample carries a class label for indicating whether the description of the text data sample conforms to the image quality of the third image sample. In this way, in a third training, a third image sample and the text data sample can be input into a second preset model to obtain a prediction similarity between the third image sample output by the second preset model and each text data sample; the parameters of the second preset model may then be updated based on the prediction similarity and the class label.

In the embodiment, the class label carried by the text data sample is used for indicating whether the description of the text data sample conforms to the image quality of the third image sample, specifically, if the text data sample conforms to the image quality of the third image sample, it is data for positive evaluation, and the class label thereof may be 1; if it is a text data sample that does not conform to the image quality of the third image sample, it is the data for reverse evaluation and its class label may be 0.

Exemplarily, taking the first image sample as an example, assuming that the inpainting task is sharpness inpainting, the sharpness of the first image sample is poor, if the text data sample is “clear image”, it is the data for reverse evaluation, and the class label thereof can be 0; and if the text data sample is “unclear image”, it is the data for positive evaluation, and the class label thereof can be 1. Taking the second image sample as an example, assuming that the inpainting task is sharpness inpainting, the sharpness of the second image sample is high if the text data sample is “clear image”, it is the data evaluated for positive evaluation, and the class label thereof can be 1; if the text data sample is “unclear image”, it is the data for reverse evaluation, and the class label thereof can be 0.

When the parameters of the second preset model are updated based on the prediction similarity and the class label, a loss corresponding to the text data sample can be determined based on the prediction similarity and the class label, then the parameters of the second preset model can be updated according to the loss, and specifically, the parameters corresponding to the text encoder and the image encoder in the second preset model can be updated.

After several parameter updates, the second preset model may be enabled to align the image and the text such that the two are compared in the same feature space, which in turn produces an accurate comparison result.

Exemplarily, there is at least one third image sample corresponding to at least two text data samples, the at least two text data samples including a text data sample of a first class and a text data sample of a second class; the first class characterizes that a description of the text data sample conforms to the image quality of the third image sample, and the second class characterizes that the description of the text data sample does not conform to the image quality of the third image sample.

Exemplarily, referring to FIG. 6, a configuration diagram of a third image sample input to a second preset model is shown; as shown in FIG. 6, a text data sample of a first class can be understood as being generated through positive evaluation of the third image sample, a class label carried thereby can be 1, characterizing that the two features are matched; a text data sample of a second class is understood to be generated through reverse evaluation of the third image sample, a class label carried thereby can be 0, characterizing that there is a mismatch between the third image sample and the text data sample.

Specifically, each third image sample may correspond to two text data samples, or part of the third image samples corresponds to two text data samples, and the remaining part of the third image samples corresponds to one text data sample; for example, 500 third image samples are included, where 200 third image samples correspond to two text data samples, namely, a text data sample of a first class and a text data sample of a second class; the remaining 200 third image samples correspond to the text data samples of the first class and the remaining 100 third image samples correspond to the text data samples of the second class.

In the case that the third image sample corresponds to at least two text data samples, one of the text data samples may be automatically generated based on the other text data sample, e.g. the text data samples of the first class may be generated based on the text data samples of the second class, or the text data samples of the second class may be generated based on the text data samples of the first class.

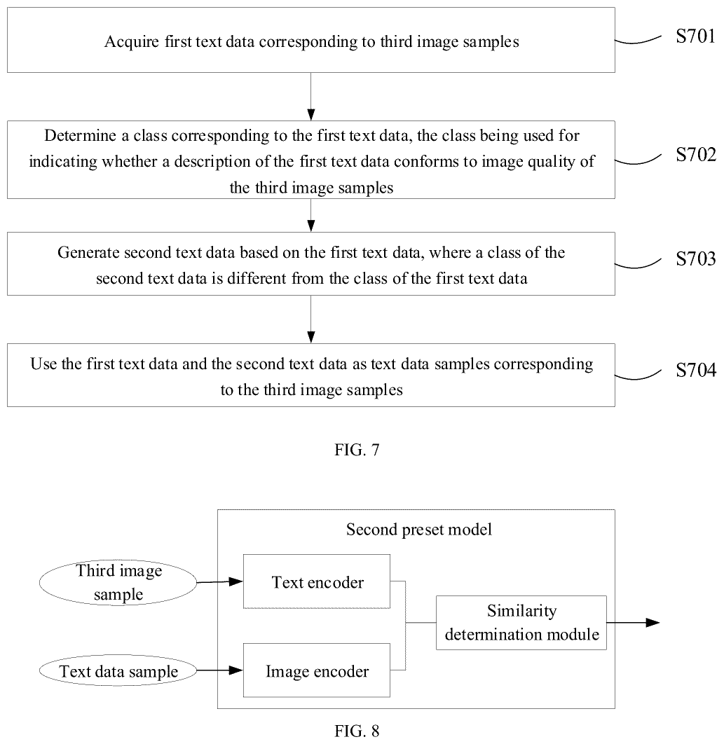

Accordingly, referring to FIG. 7, an acquisition process diagram of a text data sample corresponding to a third image sample is shown, and as shown in FIG. 7, the following steps may be specifically included:

S701: Acquire first text data corresponding to third image samples.

S702: Determine a class corresponding to the first text data, the class being used for indicating whether a description of the first text data conforms to the image quality of the third image sample.

S703: Generate second text data based on the first text data, where a class of the second text data is different from the class of the first text data.

S704: Use the first text data and the second text data as the text data samples corresponding to the third image samples.

The first text data is input by a user, and can be data of a first class or data of a second class; next, a class corresponding to the first text data can be determined, where the class to which the first text data belongs can be determined by detecting whether the first text data contains a target keyword, and the target keyword can be words related to an image inpainting task and having a negative meaning, such as “no”, “existence of noise” and “existence of scratches”.

After determining a class corresponding to the first text data, second text data opposite to the class can be generated, for example, the class corresponding to the first text data is a first class, characterizing that it conforms to the image quality of the third image sample, then the class corresponding to the second text data is a second class, characterizing that it does not conform to the image quality of the third image sample; as another example, if the class corresponding to the first text data is a second class, then the class corresponding to the second text data is the first class.

The second text data may be generated by the following: if the first text data is the first class, a word with a negative meaning in the first text data can be converted into a word with a positive meaning to obtain the second text data; for example, “not” in the first text data is removed, and “existence of noise” in the first text data is modified to “inexistence of noise”.

If the first text data is the second class, a word with a positive meaning in the first text data can be converted into a word with a negative meaning, to obtain the second text data, such as adding “not” in the first text data so that “hair is clear” becomes “hair is not clear”, and such as modifying “inexistence of noise” in the first text data to “existence of noise”.

Thus, for the first third image sample, although only one class of text data sample is labeled, another class of text data sample may be generated with the labeled text data sample, so that the third image sample may correspond to two classes of text data samples.

Accordingly, referring to FIG. 8, a model structure diagram of a second preset model is shown; the second preset model may include a text encoder and an image encoder, and a similarity determination module connected to the text encoder and the image encoder. The text encoder is configured to perform text encoding on the text data sample to obtain a prediction text vector.

The image encoder is configured to perform image encoding on the third image sample to obtain a prediction image vector, and the prediction image vector and the prediction text vector have a consistent dimension.

The similarity determination module is configured to determine a prediction similarity between the prediction image vector and the prediction text vector.

In the embodiment, in the third training, a third image sample can be input into the image encoder, and a text data sample corresponding to the third image sample can be input into the text encoder; if the third image sample corresponds to two text data samples, then the text data samples corresponding to the third image sample can both be input into the text encoder; the image encoder can encode a third image sample to obtain a prediction image vector, and the text encoder can encode a text data sample to obtain a prediction text vector; the similarity determination module can calculate the cosine distance between the prediction text vector and the prediction image vector to obtain the prediction similarity between the two.

When the third image sample corresponds to two text data samples, the text encoder can output prediction text vectors corresponding to the two text data samples, respectively; and then the similarity determination module can obtain two prediction similarities, and the two prediction similarities correspond to the two text data samples, respectively.

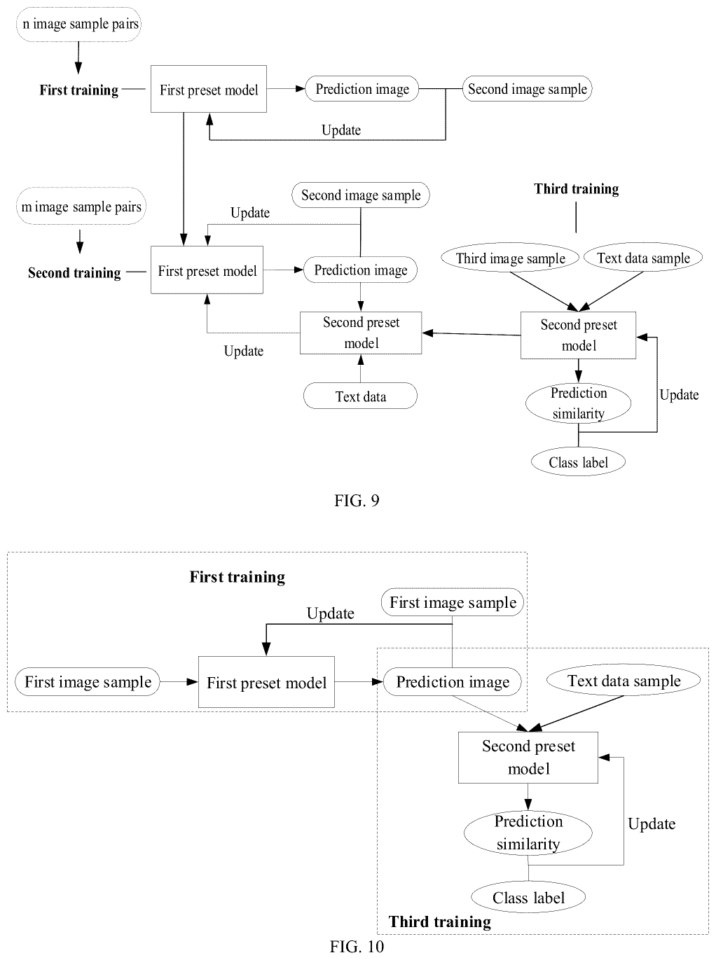

Referring to FIG. 9, a complete process diagram of a first training, a second training, and a third training is shown. As shown in FIG. 9, the third training may be performed before the first training or before the second training, that is, the second preset model may be trained before the first training starts, or the third training may be performed after the first training and before starting the second training.

Exemplarily, the third training may be performed after the first training and before starting the second training; the third image sample used may be repeated with an image sample pair used during the first training and/or with a prediction image output by the first preset model during the first training. Specifically, the plurality of third image samples may include at least one of a first image sample, a second image sample, and a prediction image output by the first preset model before a current moment.

Exemplarily, the plurality of third image samples may include all or part of the first image samples of the plurality of image sample pairs, such as the first image samples used during the first training; alternatively, the plurality of third image samples may include all or part of the second image samples of the plurality of image sample pairs, such as the second image samples used during the first training. Alternatively, the plurality of third image samples may include prediction images output by the first preset model for the first image sample in the first training; alternatively, the plurality of third image samples may include a first image sample and a second image sample, such that the third training and the first training may share image samples; alternatively, the plurality of third image samples may include the first image sample and the prediction image; or the plurality of third image samples may include a second image sample and a prediction image; alternatively, the plurality of third image samples may include a first image sample, a second image sample, and a prediction image.

In the case where a plurality of third image samples include a prediction image output by a first preset model in a first training, an image sample pair used by the second training may include an image sample pair used by the first training and such a sample setting mode is used; since the third image sample needs to correspond to a text data sample, a text data sample needs to be labeled for the prediction image, and since the labeled text data sample is used for evaluating the quality of the prediction image, in practice, when performing the second training, text data for evaluating the prediction image also needs to be acquired; then, the text data sample labeled for the third image sample in the third training can be directly used as the text data of the prediction image in the second training.

Exemplarily, a first image sample A1 corresponds to a prediction image A1 in a first training, and the prediction image A1, as a third image sample, corresponds to at least one text data sample T1; then, the first image sample A1 participates in a second training, and in the second training, corresponds to a prediction image A2, where since the difference in image quality between the prediction image A2 and the prediction image A1 is small when starting the second training, the text data sample T1 corresponding to the prediction image A1 can be used as the text data corresponding to the prediction image A2, thereby participating in the updating of the parameters of the first preset model.

When the third image sample includes the first image sample which is the corresponding prediction image in the first training, the full utilization of the labeled text data sample can be improved and the training efficiency can be improved.

Exemplarily, the first preset model can be connected to the second preset model to constitute a new model, and the first training, the second training, and the third training can be performed based on the new model. Specifically, when the first training and the second training are performed, the parameters of the second preset model can be fixed while the parameters of the first preset model are kept updated; as the third training proceeds, the parameters of the first preset model may be fixed while the parameters of the second preset model remain updated.

In the case where the third image sample includes a prediction image, the labelling of the text data sample can be performed as the first training is performed, that is, during the first training, the prediction image output by the first preset model can be used both in the parameters of the first preset model and in the process of the text data sample, for example, during the first training, the prediction images output correspond to the text data sample on the correlation, so that during the first training, the third image sample used by the third training can be collected.

Exemplarily, the third training may be performed after the first training and before starting the second training, such that the third training may be performed during a training interval of the first preset model; as described above, in case the third image sample includes a prediction image output by the first preset model for the first image sample, the text data sample corresponding to the prediction image may be utilized again in the second training of the first preset model.

Specifically, referring to FIG. 10, another process diagram of training a second preset model is shown, and as shown in FIG. 10, when the second preset model is subjected to third training based on a plurality of third image samples and text data samples, a plurality of first image samples can be input to the first preset model; and the prediction image output by the first preset model and at least two text data samples corresponding to the prediction image are input into the second preset model to perform third training on the second preset model; in the third training, the parameters of the first preset model are fixed.

In the embodiment, a third training can be performed in the first training, and in this case, at the beginning stage of the first training, the prediction image output by the first preset model and at least two text data samples corresponding to the prediction image can be input to the second preset model, and then the parameters of the first preset model are updated according to the prediction image and the second image samples; and the parameters of the second preset model are updated according to the similarity between the class label corresponding to the text data sample and the output of the second preset model.

The process of updating the parameters of the first preset model and the parameters of the second preset model can be independent of each other so that when the parameters of the first preset model are updated, the parameters of the second preset model are fixed to be unchanged; in updating the parameters of the second preset model, the parameters of the first preset model are fixed to be unchanged.

In this way, the third training can be started in parallel during the first training, so that the training progress can be improved.

Accordingly, the third image sample may further include a first image sample, and then further, in addition to inputting the prediction image output by the first preset model and at least two text data samples corresponding to the prediction image into the second preset model, when the first image sample is input into the first preset model, the first image sample and the text data samples corresponding to the first image sample may also be input into the second preset model together.

Thus, in one first training, the first image sample and the prediction image corresponding to the first image sample can be input to the second preset model together for training, so that when the first preset model is trained based on n first image samples, the second preset model can be trained based on 2n third image samples, so that the training progress of the second preset model can be accelerated.

With such implementation, if the first training is finished, the third training may be finished or continued depending on the optimization effect thereof. When the third training needs to be continued, the parameters of the first preset model are firstly fixed, and then the remaining third image samples and corresponding text data samples are input into the second preset model for retraining.

In some implementations, the prediction image fed to the second preset model for training may be the prediction image output by the first preset model at the end of the first training, such that the difference in image quality between the prediction image subjected to the third training and the prediction image output for the same first image sample in the second training is small, so that the text data sample corresponding to the prediction image may be multiplexed.

Exemplarily, a prediction image corresponding to a preset number of first image samples at the end of the first training is input to the second preset model for training, and the preset number of first image samples is input to the first preset model in the second training, and the difference between the prediction image output in the second training and the prediction image input to the second preset model is small, and therefore, text data samples can be multiplexed into text data corresponding to the prediction image in the second training for updating parameters of the first preset model.

Thus, when part of the image sample pairs are used to perform first training on the first preset model, the prediction image output during the first training is saved, then a third training is started, and when the third training is performed, a plurality of third image samples for which the third training is aimed can be acquired; the plurality of third image samples can include a plurality of prediction images output during the first training, and a text data sample is labeled for each third image sample, such that the plurality of prediction images also have text data samples respectively corresponding thereto.

Exemplarily, after the third training, a second training needs to be started in which the similarity between the prediction image and the text data needs to be determined using a second preset model. In the second training, a plurality of first image samples may be input to a first preset model; and the prediction image output by the first preset model and the text data are input into the second preset model; and the parameters of the first preset model are updated based on the prediction image, the second image sample, and the prediction similarity output by the second preset model.

The parameters of the second preset model are fixed in updating the parameters of the first preset model.

In the example, after the training of the second preset model is completed, the parameters of the second preset model can be fixed, so that in the second training, the prediction image output by the first preset model and the text data corresponding to the prediction image can be input to the second preset model, and the second preset model outputs the similarity between the prediction image and the text data, and the similarity can participate in the updating of the first preset model together with the loss value determined by the prediction image and the second image sample.

Exemplarily, whether the third image sample includes a prediction image output by a first preset model in a first training process, and in a second training, since text data corresponding to the prediction image needs to be acquired, it can be determined whether there is a target third image sample corresponding to the prediction image from the plurality of third image samples when acquiring the text data corresponding to the prediction image currently output by the first preset model; if yes, a text data sample corresponding to the target third image sample is taken as the text data; if no, the text data input for a prediction image is acquired.

The target third image sample and the prediction image correspond to the same first image sample.

In the example, in the second training, it is necessary to acquire text data corresponding to the prediction image output by the first preset model, and if the prediction image has been trained as a third image sample through the second preset model, it corresponds to a text data sample, and in practice, the labeled text data sample is directly used as text data corresponding to the prediction image.

In practice, for the same first image sample, there may be a difference between the prediction image output by the first preset model in the first training and the prediction image output by the first preset model in the second training, then when searching for the target third image sample, it is possible to search for the prediction image output by the present first preset model based on the identification of the first image sample associated with the prediction image in the third training and the identification of the first image sample input to the first preset model in the present second training, and whether the text data sample corresponding to the prediction image used in the third training can be used can be used, namely, searching for the target third image sample, and if it is found, taking the text data sample corresponding to the target third image sample as the text data corresponding to the prediction image output by the first preset model this time.

As shown in FIG. 6, in the first training, a first image sample A is input into a first preset model to obtain a prediction image A1, the prediction image A1 is labeled with a text data sample 3 and a text data sample 4; the prediction image A1, the text data sample 3, and the text data sample 4 are input as training samples into a second preset model to perform a third training; then when the second training arrives, the first image sample A is input to the first preset model again, and is output to the prediction image A2; and since the prediction image A1 and the prediction image A2 correspond to the same first image sample A, the text data sample 3 and the text data sample 4 can be input to the second preset model as the text data corresponding to the prediction image A2, and the similarity can be obtained.

It a plurality of text data samples are associated with the target third image sample, the text data sample with the reverse evaluation may be used as the text data corresponding to the prediction image. If the text data sample associated with the target third image sample is a text data sample with a positive evaluation, the text data sample can be converted into a text data sample with a reverse evaluation, and the converted text data sample can be used as the text data corresponding to the prediction image.

If the current output prediction image has not trained the second preset model as a third image sample, text data corresponding to the prediction image needs to be re-acquired; and since the text data can be input by the user, the prediction image needs to be displayed to be observed by the user; specifically, the prediction image can be displayed on a display interface, and the text data input by the user for the prediction image is acquired.

Of course, exemplarily, even if the prediction image is used as the third image sample in the third training and has a text data sample, the prediction image output by the first preset model in the first training and the prediction image output in the second training may be significantly different for the same first image sample. For example, the first training is input to a first image sample B of the first preset model at the beginning stage, and a prediction image B1 corresponding thereto is input to the second preset model; however, with the depth of the first training, the image inpainting quality of the first preset model will be optimized; then in the second training, if the first image sample B is input to the first preset model after the end of the first training, and the prediction image B2 output thereby facilitates a large difference in the prediction image B1, it is no longer suitable to use the text data sample corresponding to the prediction image B2.

In this case, instead of using the text data sample corresponding to the prediction image as the text data for updating the parameters of the first preset model, the prediction image may be displayed so that the user re-inputs the text data for the prediction image.

As described above, since the first training and the second training can be performed in stages on the first preset model, and the third training can be performed before the first training or between the first training and the second training, and the third image sample used by the third training can include the prediction image output in the first training, the prediction image output in the training can be displayed in real-time during the first training, the second training, and the third training; and the text data input by the user can be monitored during the display of the prediction image, so that the entire training stage can be visualized by the user.

In one example, when text data corresponding to the prediction image currently output by the first preset model is acquired, the prediction image may be displayed and text data input for the prediction image may be acquired.

In the example, the prediction image output by the first preset model during the training may be displayed in response to the training of the first preset model; specifically, the prediction image output by the first preset model may be displayed in either the first training or the second training, so that the user may input text data for the prediction image, and as described above, the text data may be input using an input tool on a display interface displaying the prediction image or may be input by voice.

In yet another example, after displaying the prediction image, an input operation on an operation interface displaying the prediction image may also be monitored; if the input operation is not monitored, preset text data is taken as text data corresponding to the prediction image; accordingly, when the text data input for the prediction image is acquired, the text data input for the prediction image may be acquired upon monitoring the input operation.

In the embodiment, an interface for displaying the prediction image may be referred to as an operation interface; in the operation interface, the user may input text data by an input operation, where the input operation may be an operation of typing text in the operation interface, or may be an operation of clicking a voice collection control in the operation interface; and in the case of clicking the voice collection control, the device starts to collect voice data and starts to recognize the voice data, thereby obtaining the text data.

When displaying the prediction image, a countdown of a preset duration can be started, and whether an input operation is received can be monitored during the countdown, and if no, the preset text data can be taken as text data corresponding to the prediction image. The preset text data can be text data of the prediction image with the reverse evaluation; specifically, the preset text data can be consistent with the image quality level of the second image sample, so that the process of inputting text data by the user can be eliminated.

In one example, in the first training and/or the second training, the output prediction images may be displayed so that the user observes whether the prediction images meet expectations, and if yes, the user may specify whether the training is complete. During the first training, it is possible to display the prediction image output by the first preset model, and to end the first training in response to the first preset operation performed on the prediction image; or during the second training, it is possible to display the prediction image output by the first preset model, and to end the second training in response to the second preset operation performed on the prediction image; alternatively, the outputted prediction images are displayed during both the first training and the second training, so that the user timely ends the first training and the second training according to the human eye observation of the prediction images, thereby improving the training efficiency of the models.

The first preset operation can be a click operation on an “end control” of the first training, and the second preset operation can be a click operation on an “end control” of the second training; alternatively, the first preset operation and the second preset operation may be a mouse double click or a right click operation in the operation interface, which will not be described in detail herein.

When it is detected that the first preset operation is generated, the first training on the first preset model may be stopped, and the parameters of the first preset model can be fixed. When it is detected that the second preset operation is generated, the first training on the first preset model may be stopped, and the parameters of the first preset model may be fixed.

In yet another example, during the third training of the second preset model, a loss value corresponding to at least one training of the second preset model before the current moment may also be displayed; and the third training is ended in response to a third preset operation performed on each of the displayed loss values; the gradient is determined by the prediction similarity and the class label.

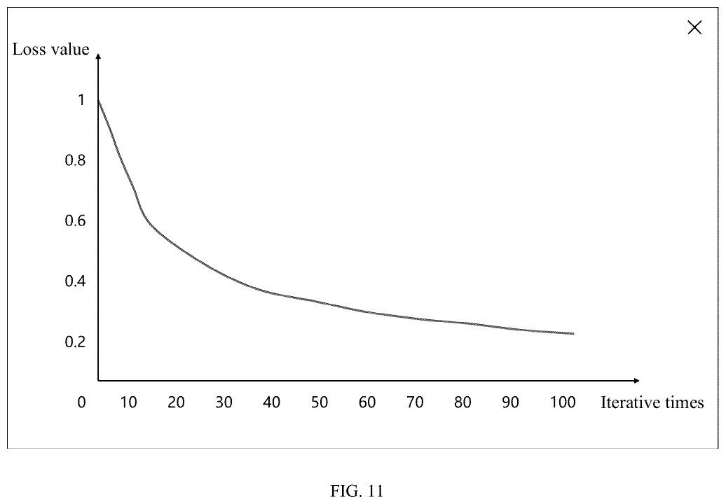

In the example, in response to the start of the third training, a loss value according to which the gradient update is performed each time in the third training can be displayed, and the loss value can be determined according to the prediction similarity and the class label corresponding to the text data sample, so that the optimization process of the second preset model can be determined according to the displayed loss value; referring to FIG. 11, a loss value variation trend graph of a second preset model during the third training is output, and as shown in FIG. 11, the loss value becomes smaller and smaller as the third training goes deeper, and when the variation curve of the loss value represents the convergence of the loss value, the third training can be ended.

The third preset operation is as described above for the first preset operation and the second preset operation, and will not be described in detail herein. In response to the third preset operation, the parameters of the second preset model can be fixed, and an input end of the second preset model can be connected to an output end of the first preset model; specifically, an input end of an image encoder in the second preset model can be connected to the output end of the first preset model.

With such an implementation, it is possible to visualize the training process of the first preset model and the second preset model, thereby facilitating the user to actively control the start timing and the end timing of each training stage in the case of training the first preset model and the second preset model in stages, thereby optimizing the model training process.

As stated above, in the case of including the first preset model and the second preset model, the output end of the first preset model can be connected to the input end of the second preset model, and the two models constitute a target model, and the target model can be referred to as a model to be trained; and in practice, the target model can be trained in stages using an image sample pair, a plurality of third image samples, and text data samples corresponding to the third image samples to obtain a trained first preset model and a trained second preset model. The trained first preset model may be used as an image inpainting model, and the trained second preset model may be used in the task of spatial alignment of text and images.

In training the target model, the following process is included:

The first stage of the training (first training) process: The first image samples are input in the image sample pair into the first preset model, and a pixel difference between the first image sample and the second image sample is calculated according to the prediction image output by the first preset model and the second image sample corresponding to the first image sample, namely, obtaining a loss value, and the parameters of the first preset model are updated according to the loss value; the second preset model is not processed in this process, that is, the prediction image is not input into the second preset model for training.

The second stage of the training (third training) process: The parameters of the first preset model are fixed, mainly including the following training methods:

The first image sample and the text data sample corresponding to the first image sample are input into the first preset model and the second preset model, and the second image sample and the text data sample corresponding to the second image sample are input into the second preset model; at the same time, the prediction image output by the first preset model and the text data sample corresponding to the prediction image are input into the second preset model, the second preset model outputs a prediction similarity between the image sample and the text data sample, and then a loss value corresponding to the second preset model is determined according to the prediction similarity and a class label corresponding to the text data sample, and then the parameters of the second preset model are updated.

The first image sample is input into the first preset model, the prediction image output by the first preset model, and the text data sample corresponding to the prediction image are input into the second preset model; the second preset model outputs the prediction similarity between the image sample and the text data sample, then the loss value corresponding to the second preset model is determined according to the prediction similarity and the class label corresponding to the text data sample, and then the parameters of the second preset model are updated.

A new image sample that is different from the first image sample, the second image sample, the prediction image, and a text data sample corresponding to the new image sample are input into the second preset model; the second preset model outputs the prediction similarity between the image sample and the text data sample, then the loss value corresponding to the second preset model is determined according to the prediction similarity and the class label corresponding to the text data sample, and then the parameters of the second preset model are updated.

The first image sample, the second image sample, the prediction image sample, and the new image sample are collectively referred to as a third image sample in the third training.

After the training in the second stage is completed, the training process in the third stage (second training) is started:

The parameters of the second preset model are fixed; the first image sample is input into the first preset model; the prediction image output by the first preset model and text data generated by the user performing reverse evaluation on the prediction image are input into the second preset model; and the second preset model outputs the similarity between the prediction image and the text data.

Next, the loss value between the prediction image and the second image sample is calculated, and the parameters of the first preset model are updated based on the similarity and the loss value.

After the training in the above-mentioned third stage is completed, the first preset model can be used as the image inpainting model.

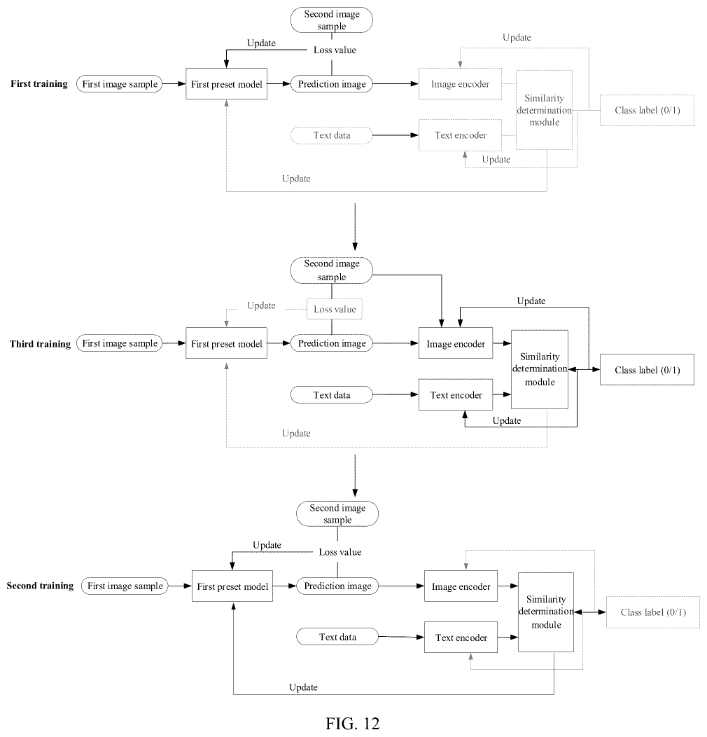

In the following, referring to FIG. 12, a process diagram of a model training method is illustrated; as shown in FIG. 12, taking portrait photograph inpainting as an example, an image inpainting model for performing portrait photograph inpainting needs to be trained, and the model training method exemplarily includes the following processes:

S11: Prepare a plurality of high-sharpness portrait photographs, photograph the plurality of portrait photographs, and take the photographed images as second image samples after pre-processing; then perform blurring processing on the plurality of portrait photographs, such as scratching or making noise on the portrait photographs, photograph the blurred portrait photographs, and take the photographed images as first image samples after pre-processing, where a first image sample and a second image sample belonging to the same portrait photograph constitute an image sample pair.

In the example, the image sample pairs may be 1000 pairs.

S12: Construct a model, including constructing a first preset model and a second preset model, where the first preset model can adopt a denoising diffusion probabilistic model (DDPM) in Diffusion Models Beat GANs on Image Synthesis or a convolutional neural network (CNN) model in the relevant art, where the first preset model is configured to perform inpainting on an input image, and the inpainting includes improving image sharpness and eliminating scratches and noise; the second preset model may include an image encoder and a text encoder, and a similarity determination module connected to the image encoder and the text encoder.

The second preset model can adopt a CLIP model structure, including two parts, a text encoder and an image encoder; the image encoder is configured to encode image feature information about the input image and output an image feature vector, and the text encoder is configured to encode text feature information about the input text and output a text feature vector.

The second preset model is connected to an output end of the first preset model, and in a subsequent training process, the model composed of the first preset model and the second preset model can be trained separately.

S13: Perform first training, and disconnect a connection between the first preset model and the second preset model in performing the first training; in the first training, input first image samples of a plurality of image sample pairs into the first preset model, display a prediction image output by the first preset model after inpainting the first image sample, and construct a loss function according to the prediction image and a corresponding second image sample to update parameters of the first preset model, where it should be noted that the second image sample for constructing the loss function and the prediction image are for the same first image sample, and the loss function may adopt a function described in the following formula (1) or formula (2):

$$Loss 1 = \frac{1}{C \times H \times W} {\sum }_{c = 1}^{C} {\sum }_{i = 1}^{H} {\sum }_{j = 1}^{W} \vert {y}_{i , j , c} - f ( {x}_{i , j , c} ) \vert \qquad Formula ( 1 )$$

$$Loss 2 = \frac{1}{C \times H \times W} {\sum }_{c = 1}^{C} {\sum }_{i = 1}^{H} {\sum }_{j = 1}^{W} {( {y}_{i , j , c} - f ( {x}_{i , j , c} ) )}^{2} \qquad Formula ( 2 )$$

In the above formula (1) and formula (2), C represents the number of channels (if the RGB image has 3 channels, then C=3, and if the grayscale image has a single channel, then C=1); H represents the height of the image; and W represents the width of the image. y is the truth image; x is the input image; and f(x) is the output image.

S14: During the first training, the user can observe an inpainting optimization process of a first preset model on a first image sample via a displayed prediction image, for example, if the quality of the prediction image is higher and higher, it indicates that the first preset model has a preliminary image inpainting capability; and for example, if the image quality of the prediction image is lower, the first image sample is continuously input to optimize the first preset model; when it is monitored that the user performs a first preset operation on the displayed prediction image, such as clicking a corresponding control on the operation interface, the first training stops, and at this moment, the parameters of the first preset model are fixed, and a third training is started.

It is assumed that when the first training stops, the first image samples for inputting into the first preset model are 340 pieces.

In the first training, a prediction image corresponding to each first image sample can be saved, to subsequently use the prediction image as a third image sample in the third training, and label a text data sample for the third image sample.

S15: Construct a new third image sample, where the third image sample can be obtained by performing image acquisition on a blurred old photograph and a clear new photograph, take a preset number of prediction images at the end of the first training approach as the third image sample, and assume that 40 prediction images finally input into the first preset model during the first training are taken as the third image sample.

The number of the third image samples is assumed to be 500, which is less than the number of the first image samples in the plurality of image sample pairs.

Each third image sample is started to label with the text data sample; the user clicks one third image sample, and an input area can be popped up on the operation interface, where the input area is used for inputting the text data sample, and the input text data sample can include text for performing positive evaluation on the third image sample; exemplarily, for the third image sample taken from the old photograph, the picture is rather blurry, and the input text may include blurry background, jagged edges, slightly high noise level, unnatural eyes, and unclear hair; and for the third image sample taken from the new photograph, the picture is rather clear, and the input text may include clear background, low noise level, and clear hair.

Of course, the same third image sample may also include the text for performing reverse evaluation on the third image sample; exemplarily, for the third image sample taken from the old photograph, the picture is rather blurry, and the input text may include clear background, low noise level, and clear hair; and for the third image sample taken from the new photograph, the picture is rather clear, and the input text may include blurry background, jagged edges, slightly high noise level, unnatural eyes, and unclear hair.

In the example, each third image sample corresponds to a text data sample of a first class and a text data sample of a second class.

Each type of text data sample corresponding to the third image sample carries a class label for characterizing the real degree of similarity between the text data sample and the image quality of the third image sample, for example, for the text data sample of the first class, the class label thereof can be set as 1, characterizing that the text data sample is a positive evaluation, and the similarity between the two is 1; for the text data sample of the second class, the class label thereof can be set as 0, characterizing that text data sample is a reverse evaluation, and the similarity between the two is 0.

S16: Start a third training, and as shown in a black part in FIG. 8, input a plurality of third image samples and text data samples corresponding to the third image samples into a second preset model, where the third image samples are input into the image encoder, the text data samples are input into the text encoder, and the similarity determination module can determine a similarity between the image feature vector output by the image encoder and the text feature vector output by the text encoder.

Then, based on the similarity and the class label carried by the text data sample, a loss value for updating the parameters of the second preset model is determined; it should be noted that in the third training, the parameters of the first preset model are fixed unchanged.

In the third training, the loss value of the second preset model during the training can be displayed, so that the user observes whether the third training needs to be completed according to the displayed loss value, and if the third training needs to be completed, the corresponding control can be triggered to end the third training and start the second training.

S17: Start a second training, where in such a training process, an output end of the first preset model needs to be connected to an input end of the second preset model.

S171: Input a first image sample of 1000 image sample pairs into the first preset model, where since a third image sample used in training the second preset model includes 40 prediction images finally output by the first preset model during the first training, 40 first image samples corresponding to 40 prediction images can be firstly input into the first preset model to use the text data samples labeled in the third training.

The quality difference between the prediction image output by the first preset model and the prediction image output during the first training is not large, and therefore text data samples corresponding to 40 prediction images can be used as text data; specifically, when 40 first image samples corresponding to 40 prediction images are input into the first preset model, text data samples corresponding to the 40 prediction images are input into the second preset model, and the prediction images output by the first preset model are also input into the second preset model, so that the second preset model can output similarity, and the loss value between the prediction image and the second image sample is calculated via formula (1) or formula (2), and then parameters of the first preset model are updated according to the loss value and similarity.

After 40 first image samples corresponding to 40 prediction images are firstly input into the first preset model and then are trained, the remaining 960 image sample pairs in 1000 image sample pairs can be used to continue training the first preset model.

S172: Continue training process:

The first image sample in 960 image sample pairs is input into the first preset model, and the prediction image output by the first preset model can be input into the second preset model and displayed in a display area of a front-end operation interface.

The operation interface also has an input area parallel to the display area, and the user inputs text data corresponding to the displayed prediction image in the input area; in the second training, the input text data is the data with the reverse evaluation, and if the current picture feedback is that human hair is not clear, the input text data is hair clear. In this way, the image feature vector of the prediction image needs to be close to the text semantic vector of “hair clear” to stimulate the first preset model to train in the direction of hair clear; if the user does not input text in the input area, the default preset text with the reverse evaluation is used as text data.

The text data input in the input area is input to the second preset model, and the second preset model outputs the similarity between the prediction image and the text data, and the loss value between the prediction image and the second image sample is calculated via formula (1) or formula (2), and then the parameters of the first preset model are updated according to the loss value and the similarity.

It should be noted that in the second training, the parameters of the second preset model are fixed.

During the second training, the user can determine an image inpainting capability of the first preset model via the displayed prediction image, and when the image quality of the prediction image is always at a high level, the user can trigger a second preset operation to end the second training; of course, the second training may also be ended when both the loss value and the similarity value approach the respective corresponding preset thresholds.

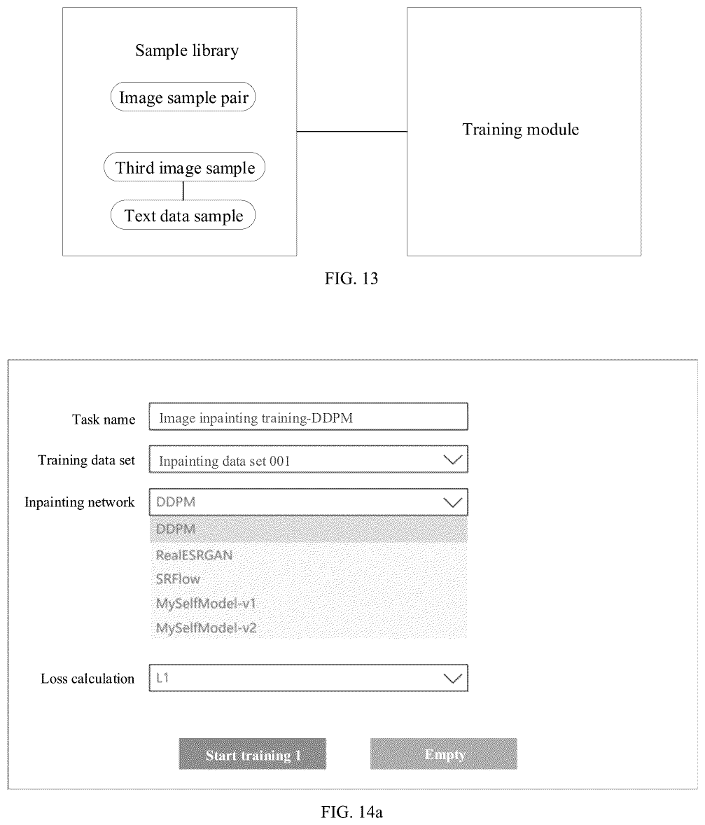

Based on the same inventive concept, the present disclosure also provides a model training platform, and referring to FIG. 13, a frame structural diagram of a model training platform is shown; as shown in FIG. 13, the model training platform may specifically include a sample library and a training module.

The sample library is configured to store a plurality of image sample pairs, where the image sample pair includes a first image sample and a second image sample of a same image; and image quality of the second image sample is higher than image quality of the first image sample.

The training module is configured to perform a plurality of training on a first preset model with the plurality of image sample pairs as training samples in response to a training operation, where the first preset model is configured to improve the image quality of the first image sample, and a process of the training includes:

acquiring text data corresponding to a prediction image currently output by the first preset model, where the text data is used for describing an image quality difference between the prediction image and the second image sample;

updating parameters of the first preset model based on the text data, the prediction image, and the second image sample.

The model training platform provided in the embodiment may include a sample library and a training module connected to the sample library, where the training module may deploy a first preset model, and the training module may extract a plurality of image sample pairs from the sample library in response to the training operation, and input a first image sample of the image sample pairs into the first preset model to start training the first preset model.

As described in the above embodiments, there may be at least one of the following training methods during the training of the first preset model: acquiring text data corresponding to a prediction image currently output by the first preset model; and updating parameters of the first preset model based on the text data, the prediction image, and the second image sample, where the text data includes data for evaluating image quality of the prediction image.

Accordingly, if the text data is data generated by performing a positive evaluation on the prediction image, and the text data is consistent with the image quality of the prediction image, the target text with the opposite semantics of the text data can be determined to determine the similarity between the target text and the prediction image, and then the loss value between the prediction image and the second image sample is determined; when the loss is determined, it can be performed according to the above-mentioned formula (1) or formula (2), and thus the parameters of the first preset model can be updated according to the loss value and the similarity.

A plurality of image sample pairs included in the sample library can be uploaded by the user in advance, and the acquisition process of the image sample pairs can be referred to the description in the above model training method embodiment, and will not be described in detail herein.

With such a training platform, the training module can train the first preset model with a plurality of image samples acquired from the sample library as training samples. During the training, a region to be optimized having a difference from an expected image quality in the prediction image can be determined through text data, and thus when updating the first preset model, the region to be optimized can be fed back to the first preset model, and the first preset model is supervised to strengthen learning on the inpainting of the region to be optimized, to guide the first preset model to perform continuous optimization on a weak link of image inpainting, which helps to improve the quality of image inpainting.

As described in the above-mentioned embodiments, the training on the first preset model can be performed in stages, including a first training stage, a second training stage, and a third training stage. The first training stage trains the first preset model using part of the image sample pairs, and during the training, the parameters of the first preset model are updated based on the prediction image output by the first preset model and the second image sample; during the second training, parameters of the first preset model are updated based on the prediction image output by the first preset model, the second image sample, and text data corresponding to the prediction image; during the third training, the second preset model is trained based on the third image sample and the text data sample.

Exemplarily, to enable the first preset model to intuitively visualize the training stage as well as control the switching between the training stages during the training in stages, the training platform can also provide an operation interface; the operation interface can include a control area, and the control area can include a plurality of controls; different controls are used for starting different training when being triggered.

The training includes a first training and a second training, the first training including updating the parameters of the first preset model based on the prediction image output by the first preset model and the second image sample.

The second training includes updating the parameters of the first preset model obtained by the first training based on the text data, the prediction image, and the second image sample.

In the embodiment, the training module may start a corresponding training stage in response to the triggering of a corresponding control in the operation interface; for example, in response to the triggering of the first control in the operation interface, a plurality of image sample pairs may be acquired from the sample library, and the acquired plurality of image sample pairs are used as training samples to start first training on the first preset model. Starting the first training may mean that the training module starts a first thread corresponding to the first training, and when the first thread runs, a first image sample in the acquired image sample pair may be input into the first preset model, and the prediction image output by the first preset model and the second image sample can be calculated as the loss function, and then parameters of the first preset model are updated according to a value of the loss function.

In response to the triggering the second control in the operation interface, a second thread corresponding to the second training may be started and the first thread may be kept running; when the second thread is running, a first image sample among the acquired image sample pairs may be input to the first preset model, and the prediction image outputted from the first preset model may be displayed, as well as monitoring the text data inputted for the prediction image; next, it is determined that whether the text data is data generated by the positive evaluation of the prediction image, if yes, the text data is converted to the target text (data for reverse evaluation of the prediction image), and a similarity between the target text and the prediction image is calculated; if no, a similarity between the text data and the prediction image is calculated.

Since the first thread remains running, the first thread will calculate a loss value between the prediction image and the second image sample, and in this case, the second thread will feed back the similarity to the first thread; when receiving the similarity, the first thread starts to update the parameters of the first preset module according to the similarity and the loss value.

Of course, as mentioned above, a control may also include a control that triggers a third training, and the third training includes: inputting the plurality of third image samples and at least two text data samples corresponding thereto into the second preset model to train the second preset model; the second preset model when the third training is completed is configured to determine the similarity between the prediction image and the text data in the training of the first preset model.

The control that triggers the third training can be referred to as a third control; when the third control is triggered, a third thread corresponding to the third training can be started; when the third thread is started, a third image sample and a corresponding text data sample can be acquired from the sample library; the third image sample and the text data sample are input into the second preset model; a loss value is determined according to a prediction similarity output by the second preset model and a class label corresponding to the text data sample; and parameters of the second preset model are updated based on the loss value.

As stated above, steps of the performing third training on the second preset model is performed in training the first preset model; the plurality of third image samples include at least one of the following: the first image sample, the second image sample, and a prediction image output by the first preset model before a current moment.

Since the third image sample may include the prediction image output during the first training, in one implementation, the first thread may save each prediction image output to the sample library and associate the same with the first image sample; before the start of the third training, a fourth thread of the labelling may retrieve the prediction image from the sample library and display the prediction image in response to the labelling of the third image sample; and then, the text data sample can be obtained for the displayed prediction image, and the text data sample can be associated with the prediction image and saved to the sample library.

In another implementation, the training module may, in response to a data labelling function started in the first training, instruct the first thread to display the prediction image in the display interface after obtaining the prediction image of the first preset model; and then the fourth thread may start in response to an input operation triggered on the display interface, acquire text data samples input for the displayed prediction image, and store the text data samples in the sample library together after associating with the prediction image; and simultaneously, the parameters of the first preset model are updated according to a loss value between the prediction image and the second image sample.

In either implementation, the prediction image and the corresponding text data sample may be input to the second preset model from the sample library for training upon starting the third thread.

As described above, the text data sample needs to be associated with the prediction image so that the text data sample can be found in the second training based on this association for use in updating the parameters of the first preset model. Accordingly, the training platform may further include an association unit and an output unit; the association unit may be configured to associate the text data sample input by the input area with the prediction image when displaying the prediction image.

The output unit may be configured to output the text data sample associated with the prediction image currently output by the first preset model as the text data when the first preset model is subjected to the second training.

Specifically, the output unit may monitor the prediction image output by the first preset model while the second thread is running, find a text data sample associated with the prediction image from the sample library, and send the text data sample to the second thread so that the second thread may input the text data sample output by the output unit to the second preset model.

Exemplarily, to enable the first preset model to intuitively visualize the training stage during the training in stages, the operation interface may further include a display area and an input area.

The display area is used for displaying at least one of the following: the prediction image output by the first preset model, the third image sample, and the loss value during the third training; the loss value is determined by the prediction similarity output by the second preset model and the class label; the class label is used for indicating whether the description of the text data sample conforms to the image quality of the third image sample.

The input area is used for the user to input the text data and text data samples.

In both the second training and the first training, the first thread can output the prediction image to the display interface for display; exemplarily, the first thread sends the prediction image to the front-end interface rendering thread of the training platform, and the front-end interface rendering thread renders the prediction image into the display area; accordingly, the first thread, whether in the first training or the second training, can perform this operation of outputting the prediction image to the front-end interface rendering thread, to help the user visually observe the optimization degree of the first preset model in the first training and the second training.

In the third training, the third thread can send the calculated prediction similarity and the loss between the class labels to the front-end interface rendering thread of the training platform, and the front-end interface rendering thread renders the prediction image into the display area.

In one example, the front-end interface rendering thread may record the received loss values and may, in response to a triggering operation on the change curves of the loss values on the front-end interface (display interface), generate gradient change curves based on the plurality of loss values and the moments corresponding to the plurality of loss values and render the gradient change curves to the display area, so that the user may determine, through the gradient change curves, whether or not the second preset model is converging.

In yet another example, the front-end rendering thread can display the received loss values in real-time, for example, near the display area, so that in the third training, the user can determine the optimization degree of the second preset model in the third training using the loss value displayed in real-time.

In some examples, the third image sample used for the third training may correspond to two text data samples, the two text data samples including a text data sample of a first class and a text data sample of a second class; the first class characterizes that a description of the text data sample conforms to the image quality of the third image sample, and the second class characterizes that the description of the text data sample does not conform to the image quality of the third image sample.

Accordingly, in the embodiment, the first text data may be sent to a fifth thread in response to the first text data input in the input area for the displayed third image sample, and the fifth thread performs the following steps:
determining a class corresponding to the first text data, the class being used for indicating whether a description of the first text data conforms to the image quality of the third image sample;
generating second text data based on the first text data, where a class of the second text data is different from the class of the first text data; and
using the first text data and the second text data as the text data samples corresponding to the third image samples.

The fifth thread can bind the first text data and the second text data to the third image sample before associating and storing them in the sample library.

Accordingly, in the third training, the third thread can acquire the third image sample and the first text data and the second text data corresponding to the third image sample from the sample library, and input the third image sample, the first text data, and the second text data into the second preset model to update the parameters of the second preset model according to the prediction similarities and the class labels corresponding to the two text data samples.

Accordingly, the second preset model may include an image encoder, a text encoder, and a similarity determination module; the third thread may input the third image sample into the image encoder of the second preset model, and input the text data sample corresponding to the third image sample into the text encoder of the second preset model; the similarity determination module determines a prediction similarity between the text data sample and the third sample image; and then the third thread may update parameters of the second preset model according to the prediction similarity and a class label.

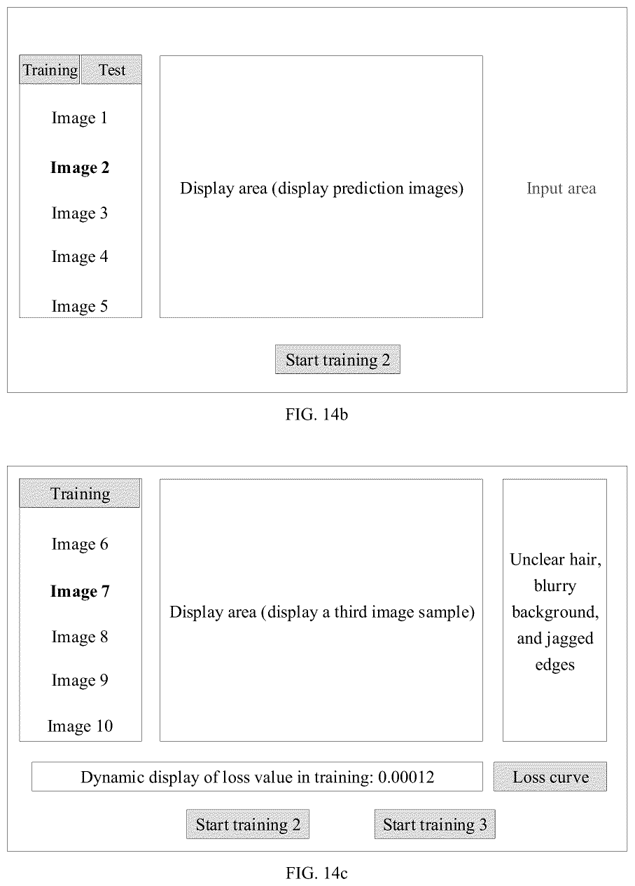

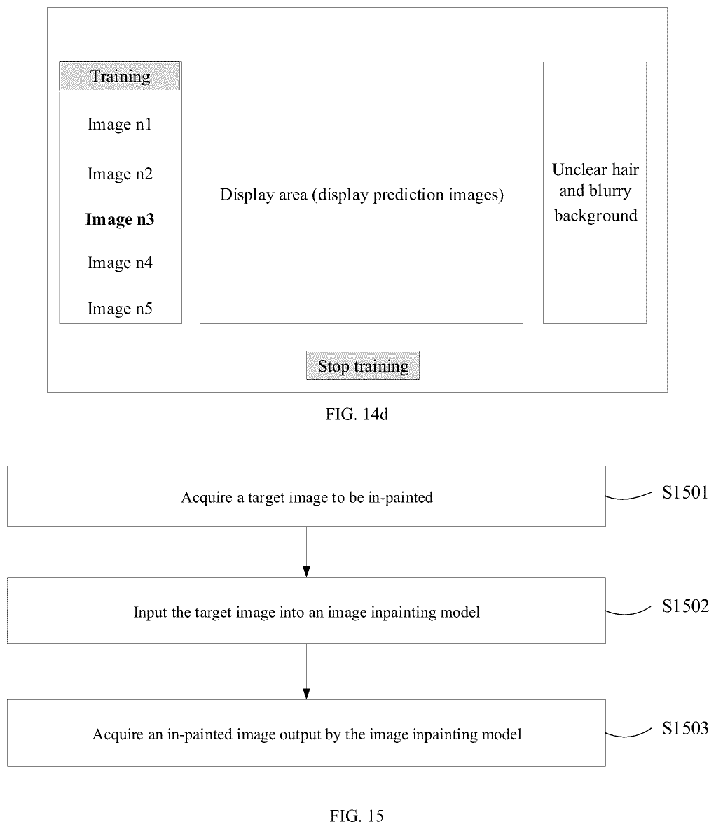

The following, combined with a specific example, introduces the process of performing model training on the disclosed model training platform. Referring to FIG. 14a to FIG. 14e, diagrams of operation interfaces of the model training platform during performing model training are shown.

S21: As shown in FIG. 14a, first, in response to a user creating a model training task, a first operation interface may be output in which setting fields required to create the training task are presented. These include, but are not limited to: several options of task name, training data set, network structure of the first preset model, network structure of the second preset model and loss calculation; when the setting is completed, click the control of “start training 1” (the first control) in the first operation interface to start the first training.

S22: As shown in FIG. 14b, when the control of “starting training 1” in the first operation interface is triggered, the operation platform outputs a second operation interface; a plurality of image sample pairs in the sample library for performing the first training can be selected in the second operation interface; a list of the first image samples in the selected image sample pairs, such as image 1, and image 2 to image 5, can be displayed on the second operation interface; and the first image sample currently input to the first preset model for training can be highlighted in the list, such as black and bold representing the first image sample currently input to the first preset model for training.

In response to the triggering of the first control, the first thread starts running, a plurality of first image samples displayed in the list can be automatically input to the first preset model in an order; the first thread can calculate a loss value based on the prediction image output by the first preset model and the second image sample, and then update parameters of the first preset model according to the loss value.

At the same time, in the first training, the second operation interface includes a display area and an input area, and a first image sample currently input to the first preset model for training and a prediction image output after being in-painted can be displayed in the display area; in the example, the input area in the second operation interface can be locked so as not to support text labelling on the prediction image, that is, in the first training, text data sample labelling on the prediction image cannot be performed.

When thinking that the first preset model has been trained to the effective state according to the displayed prediction image, the user can click the “start training 2” button (the third control) below, and then start the third training.

In the second operation interface, the prediction image and the first image sample can be allowed to be displayed in the display area; if the first image sample can be clicked in the display area, switch to display the prediction image, and click the prediction image, switch to display the first image sample.

During the first training, the prediction image output by the first preset model can be saved into the sample library to subsequently label the prediction image as the third image sample.

S23: As shown in FIG. 14c, when the control of “start training 2” (the third control) in the second operation interface is triggered, a third operation interface is output to start performing the third training.

In the third training, a list of third image samples can be displayed on the third operation interface; specifically, in response to the third training, a third image sample accurate for the third training can be acquired from the sample library, and a preset number of prediction images at the end of the first training can be acquired from the sample library, and these images can all be displayed as third image samples in the list of the third operation interface, such as image 6, and image 7 to image 10; the third image sample to be currently labeled can be highlighted in the list, such as black and bold representing the third image sample to be currently labeled; the third operation interface further includes a display area, and a selected third image sample can be displayed in the display area; the third operation interface further includes an input area, and at this time, in the third training stage, the input area is unlocked and text can be allowed to be input.

The user can input a text expression in the input area and set a class label for the input text expression; at this time, the third image sample displayed in the display area and the text input in the input area are bound. If a third image sample is selected, and when the user observer considers that there is no problem, the third image sample is considered to be an image sample with a high image quality, it may not be necessary to fill in text in the input area; the training platform may directly take the first preset text data as a text data sample of a first class of the third image sample, and/or take the second preset text data as a text data sample of a second class of the third image sample.

Then, the next third image sample can be clicked directly for labelling, and when all the third image samples are labelled, button of complete labelling is clicked, and then the third training is started.

At this time, the third thread starts running, including: inputting the third image sample and the corresponding text data sample into the second preset model, determining a loss value according to the prediction similarity output by the second preset model and the class label carried by the text data sample, and updating parameters of the second preset model according to the loss value.

S24: As shown in FIG. 14c, in the third operation interface, the loss value obtained in the third training can also be displayed in real-time; in FIG. 14c, “dynamic display of loss value in training: 0.00012”, where 0.00012 is the loss value in the third training.

A fourth control can further be set in the third operation interface, such as the control “view loss curve” in FIG. 14c, when the fourth control is triggered, various loss values corresponding to the second preset model during the third training may be displayed in the third operation interface, and as shown in FIG. 11, the current existing loss value records of the third training may be dynamically displayed.

The user can judge whether the third training needs to be ended according to the displayed loss value, and if yes, a control (a second control) of “start training 3” can be clicked, so that the second training can be started in response to the triggering of the second control.

S4: As shown in FIG. 14d, when the control of “start training 3” in the third operation interface is triggered, a fourth operation interface is output to start performing the second training.

The second training is a mode of labelling text while training; the fourth operation interface still includes a list, and the list includes a plurality of first image samples, such as images n1 to n5, as training samples, where the first image samples corresponding to the prediction images used for the third training can be arranged at the top, that is, a preset number of first image samples are arranged at the top in the list, and the prediction images corresponding to these first image samples have text data samples bound in the sample library.

For the first preset number of first image samples, in response to a selection operation on an image identifier displayed in the list, the selected first image sample can be input into the first preset model; the prediction image output by the first preset model for the first image sample will be displayed in a display area of the third operation interface; a text data sample corresponding to the prediction image acquired from the sample library is displayed in the input area; then, an operation in the display area can be monitored; and if the user clicks the input area and updates the text data, the text data newly input by the user will be sent to the second thread; the second thread calculates similarity based on the input text data and the prediction image, and feeds back same to the first thread; if the user does not click the input area and updates the text data, the text data sample is sent to the second thread, and the second thread calculates the similarity based on the input text data sample and the prediction image, and feeds back same to the first thread.

For a subsequent first image sample, in response to a selection operation on an image identifier displayed in the list, the selected first image sample can be input into the first preset model; the prediction image output by the first preset model for the first image sample would be displayed in a display area of the third operation interface; and an operation in the display area can be monitored; text data input by the user in the input area is acquired, and the text data is sent to the second thread; and the second thread calculates similarity based on the input text data and the prediction image, and feeds back same to the first thread.

The first thread updates the parameters of the first preset model in the second training based on the similarity sent by the second thread and the loss value between the prediction image and the second image sample.

The first thread updates the parameters of the first preset model in the first training based on the loss value between the prediction image and the second image sample.

When the third thread executes the third training, the first thread and the second thread do not run to fix the parameters of the first preset model; and when the first thread and the second thread run, the third thread does not run to fix the parameters of the second preset model.

In summary, with the model training platform provided in the present disclosure, through the operation interface, the training module, and the display area, the input area, and the plurality of controls arranged on the operation interface, the user can be assisted to train the first preset model in stages, and in the training, and observe the optimization degree of the image inpainting model during the training through the prediction image displayed in the display area; the evaluation text of the prediction image is input in the input area, so that during the training of the first preset model, according to the optimization direction indicated by the evaluation text, the first preset model is guided to update the parameters towards the optimization direction, to supervise the model training from the human perspective in the image inpainting scene, which makes a new attempt and exploration for the model training in the field of image inpainting, to optimize the model training mechanism and make a contribution to improving the image quality of the first preset model.

Based on the same inventive concept, the present disclosure further provides an image inpainting method, and referring to FIG. 15, a step flow diagram of an image inpainting method is shown; as shown in FIG. 15, the method may specifically include the following steps: S1501: Acquire a target image to be in-painted.

S1502: Input the target image into an image inpainting model, where the image inpainting model is a first preset model trained according to the model training method.

S1503: Acquire an in-painted image output by the image inpainting model, where image quality of the in-painted image is higher than that of the target image.

In the embodiment, the target image may refer to an image with poor image quality, such as an old photograph and a movie film data having scratches.

The image inpainting model is the first preset model described in the above-mentioned embodiment, and the training process thereof can be completed with reference to the description of the above-mentioned embodiment, which will not be described again. An in-painted image output by the image inpainting model can be acquired; and since the image inpainting model is configured to perform inpainting processing on an image, the image quality of the in-painted image is higher than that of the target image.

Exemplarily, if the image inpainting task of the image inpainting model is sharpness inpainting, the sharpness of the in-painted image is higher than that of the target image; for another example, if the image inpainting task of the image inpainting model is scratch inpainting, the scratches of the in-painted image are less than that of the target image; then, if the image inpainting task of the image inpainting model is missing part inpainting, the missing image region in the target image is restored to image details; for another example, if the image inpainting task of the image inpainting model is noise inpainting, the noise in the in-painted image is less than that in the target image.

With the image inpainting method of the embodiment, since the image inpainting model used is trained according to the embodiment of the above-mentioned model training method, and in the training, since the parameters of the first preset model can be updated using the text data, the prediction image, and the second image sample, and the text data thereof also includes data for evaluating the image quality of the prediction image, it is possible to supervise the training not only based on the pixel difference between the prediction image output by the model and the second image sample, but also based on the difference of the visual evaluation of the prediction image by human vision. Thus, the model acquires the ability to perceive human vision, so that the optimization direction of the first preset model can be guided based on face vision, and then the image inpainting quality of the trained model can be improved, so that the image inpainting quality of the target image can be improved.

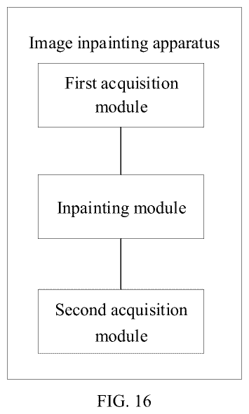

Based on the same inventive concept, the present disclosure further provides an image inpainting apparatus, and referring to FIG. 16, a structural diagram of the image inpainting apparatus is shown; as shown in FIG. 16, the apparatus may specifically include the following modules:
a first acquisition module, configured to acquire a target image to be repaired;
an input module, configured to input the target image into an image inpainting model, where the image inpainting model is a first preset model trained according to the model training method; and
a second acquisition module, configured to acquire an in-painted image output by the image inpainting model, where image quality of the in-painted image is higher than that of the target image.

The description of the apparatus embodiment can be detailed in the description of the method embodiment above and will not be repeated here.

The embodiments of the present disclosure further provide a computer-readable storage medium storing computer programs that cause a processor to execute the model training method or the image inpainting method as described in the embodiments of the present disclosure.

Each embodiment described in this specification is presented in a progressive manner, with each embodiment focusing on the differences from the others. Similar or identical parts among the embodiments can be cross-referenced accordingly.

Furthermore, it should be noted that in this document, relational terms such as “first” and “second” are used solely to distinguish one entity or operation from another, without necessarily implying any actual relationship or sequence between these entities or operations. Additionally, terms such as “comprising,” “including,” or any other variants thereof are intended to encompass non-exclusive inclusion, such that processes, methods, products, or devices comprising a series of elements include not only those elements explicitly listed but also other elements not explicitly listed, or inherent elements of such processes, methods, products, or devices. In the absence of further limitations, the inclusion of an element specified by the phrase “comprising a . . . ” does not exclude the presence of additional identical elements in processes, methods, products, or devices comprising the specified element.

The above detailed descriptions have been provided for a model training method and platform, an image restoration method, apparatus, devices, and media disclosed herein. Specific examples have been utilized in this document to elucidate the principles and embodiments disclosed herein. The explanations of the above embodiments are intended solely to aid in understanding the methods and core concepts disclosed herein. However, it should be noted that for those skilled in the art, changes may be made in the specific implementation methods and application scope based on the principles disclosed herein. Therefore, the contents of this specification should not be construed as limiting the disclosure herein.

Those skilled in the art, after considering the disclosure and practicing the invention disclosed herein, will readily conceive of other embodiments of the disclosure. The disclosure herein is intended to cover any variations, uses, or adaptations of the disclosure, which follow the general principles disclosed herein and include common knowledge or conventional techniques within the technical field not disclosed herein. The specification and embodiments are merely exemplary, and the true scope and spirit of the disclosure are indicated by the following claims.

It should be understood that, the disclosure herein is not limited to the precise structures described and illustrated in the figures above and may be subject to various modifications and changes within the scope thereof. The scope of the disclosure herein is only limited by the appended claims.

The terms “one embodiment,” “embodiment,” or “one or more embodiments” as used herein mean that specific features, structures, or characteristics described in conjunction with an embodiment are included in at least one embodiment disclosed herein. Additionally, it should be noted that the phrase “in one embodiment” or similar expressions do not necessarily refer to the same embodiment throughout.

While this specification provides many specific details, it should be understood that embodiments of the disclosure may be practiced without these specific details. In some instances, well-known methods, structures, and techniques are not shown in detail to avoid obscuring understanding of this specification.

In the claims, any reference signs placed in parentheses should not be construed as limiting the claims. The word “comprising” does not exclude the presence of elements or steps not listed in the claims. The use of the words “a” or “an” preceding an element does not exclude the presence of multiple such elements. The disclosure may be implemented with hardware including several different components and with a computer programmed appropriately. In the enumeration of several apparatus units in the claims, several of these units may be embodied by the same hardware item. The use of the words “first,” “second,” and “third,” etc., does not imply any order, and these words may be interpreted as names.

Finally, it should be noted that the above embodiments are provided for illustrative purposes only and are not intended to limit the disclosure. Although detailed descriptions have been provided with reference to the aforementioned embodiments, those skilled in the art should understand that they can still modify the technical solutions described in the aforementioned embodiments or replace some technical features with equivalent ones without departing from the essence and scope of the technical solutions disclosed in the various embodiments.

1. A model training method, comprising:
acquiring a plurality of image sample pairs, wherein the image sample pair comprises a first image sample and a second image sample of a same image; and image quality of the second image sample is higher than image quality of the first image sample; and
training a first preset model with the plurality of image sample pairs as training samples, wherein the first preset model is configured to improve the image quality of the first image sample, and a process of the training comprises:
acquiring text data corresponding to a prediction image currently output by the first preset model, wherein the text data comprises data for evaluating image quality of the prediction image; and
updating parameters of the first preset model based on the text data, the prediction image, and the second image sample.

2. The method according to claim 1, wherein the updating parameters of the first preset model based on the text data, the prediction image, and the second image sample comprises:
determining a similarity between a target text and the prediction image, wherein the target text is the text data or a text with semantics opposite to that of the text data;
determining a loss value based on the prediction image and the second image sample; and
updating the parameters of the first preset model based on the similarity and the loss value.

3. The method according to claim 2, wherein the determining a similarity between a target text and the prediction image comprises:
encoding the target text to obtain a text feature vector of the target text;
encoding the prediction image to obtain an image feature vector of the prediction image, wherein the text feature vector and the image feature vector have a consistent dimension; and
determining the similarity based on the text feature vector and the image feature vector.

4. The method according to claim 1, wherein the training a first preset model with the plurality of image sample pairs as training samples comprises:
performing first training on the first preset model with part of the image sample pairs as training samples, wherein in the first training, the parameters of the first preset model are updated based on the prediction image output by the first preset model and the second image sample; and
performing second training on a first preset model obtained by the first training with part of or all the image sample pairs as training samples, wherein
in the second training, parameters of the first preset model obtained by the first training are updated based on the text data, the prediction image, and the second image sample.

5. The method according to claim 1, further comprising:
acquiring a plurality of third image samples and text data samples corresponding to the third image samples, wherein the text data sample is used for describing image quality of the third image sample;
performing third training on a second preset model based on the plurality of third image samples and the text data samples, wherein the second preset model is configured to determine a similarity between the third image sample and the text data sample; and
the updating parameters of the first preset model based on the text data, the prediction image, and the second image sample comprising:
inputting the prediction image and the text data into a second preset model after completion of the third training; and
updating the parameters of the first preset model based on the similarity output by the second preset model, the prediction image, and the second image sample.

6. The method according to claim 5, wherein the text data sample carries a class label, the class label is used for indicating whether a description of the text data sample conforms to the image quality of the third image sample; the performing third training on a second preset model based on the plurality of third image samples and at least two corresponding text data samples comprises:
inputting the third image samples and the text data samples into the second preset model to obtain a prediction similarity between the third image sample and each text data sample; and
updating parameters of the second preset model based on the prediction similarity and the class label.

7. The method according to claim 5, wherein the third image sample corresponds to a text data sample of a first class and a text data sample of a second class; the first class characterizes that a description of the text data sample conforms to the image quality of the third image sample, and the second class characterizes that the description of the text data sample does not conform to the image quality of the third image sample.

8. The method according to claim 5, wherein the second preset model comprises a text encoder and an image encoder, and a similarity determination module connected to the text encoder and the image encoder, wherein
the text encoder is configured to perform text encoding on the text data sample to obtain a prediction text vector;
the image encoder is configured to perform image encoding on the third image sample to obtain a prediction image vector, wherein the prediction image vector and the prediction text vector have a consistent dimension; and
the similarity determination module is configured to determine a prediction similarity between the prediction image vector and the prediction text vector.

9. The method according to claim 5, wherein steps of the performing third training on the second preset model is performed in training the first preset model; the plurality of third image samples comprise at least one of the following: the first image sample, the second image sample, and a prediction image output by the first preset model before a current moment.

10. The method according to claim 5, wherein the third training is performed during an interval in training the first preset model; the third image sample comprises a prediction image output by the first preset model for the first image sample; and the performing third training on a second preset model based on the plurality of third image samples and the text data samples comprises:
inputting a plurality of first image samples into the first preset model; and
inputting the prediction image output by the first preset model and a text data sample corresponding to the prediction image into the second preset model to perform the third training on the second preset model, wherein
in the third training, the parameters of the first preset model are fixed.

11. The method according to claim 5, wherein after the third training, the training a first preset model comprises:
inputting a plurality of first image samples into the first preset model;
inputting the prediction image output by the first preset model and the text data into the second preset model; and
updating the parameters of the first preset model based on the prediction image, the second image sample, and the prediction similarity output by the second preset model, wherein
the parameters of the second preset model are fixed in updating the parameters of the first preset model.

12. The method according to claim 5, wherein the acquiring a plurality of third image samples and text data samples corresponding to the third image samples comprises:
acquiring first text data corresponding to the third image samples;
determining a class corresponding to the first text data, the class being used for indicating whether a description of the first text data conforms to the image quality of the third image sample;
generating second text data based on the first text data, wherein a class of the second text data is different from the class of the first text data; and
using the first text data and the second text data as the text data samples corresponding to the third image samples.

13. The method according to claim 5, wherein the acquiring text data corresponding to a prediction image currently output by the first preset model comprises:
determining whether a target third image sample corresponding to the prediction image exists from the plurality of third image samples, wherein the target third image sample and the prediction image correspond to the same first image sample;
if yes, using a text data sample corresponding to the target third image sample as the text data; and
if no, acquiring text data input for the prediction image.

14. The method according to claim 1, wherein the acquiring text data corresponding to a prediction image currently output by the first preset model comprises:
displaying the prediction image; and
acquiring text data input for the prediction image.

15. (canceled)

16. The method according to claim 1, wherein the text data comprises at least one entry; the at least one entry is used for describing image quality of the prediction image in different image regions and/or different quality dimensions.

17. The method according to claim 4, further comprising at least one of the following:
displaying the prediction image output by the first preset model in response to the first training, and ending the first training in response to a first preset operation performed on the prediction image; and
displaying the prediction image output by the first preset model in response to the second training, and ending the second training in response to a second preset operation performed on the prediction image.

18. The method according to claim 6, in performing the third training on the second preset model, further comprising:
displaying a loss value corresponding to at least one training of the second preset model before a current moment, wherein a gradient is determined by the prediction similarity and the class label; and
ending the third training in response to a third preset operation performed on each loss value displayed.

19. An image inpainting method, comprising:
acquiring a target image to be in-painted;
inputting the target image into an image inpainting model, wherein the image inpainting model is a first preset model trained by the model training method according to claim 1; and
acquiring an in-painted image output by the image inpainting model, wherein image quality of the in-painted image is higher than that of the target image.

20. A model training platform, comprising:
a sample library, configured to store a plurality of image sample pairs, wherein the image sample pair comprises a first image sample and a second image sample of a same image; and image quality of the second image sample is higher than image quality of the first image sample; and
a training module, configured to perform a plurality of training on a first preset model with the plurality of image sample pairs as training samples, wherein the first preset model is configured to improve the image quality of the first image sample, and a process of the training comprises:
acquiring text data corresponding to a prediction image currently output by the first preset model, wherein the text data comprises data for evaluating image quality of the prediction image; and
updating parameters of the first preset model based on the text data, the prediction image, and the second image sample.

21. (canceled)

22. An electronic device, comprising a memory, a processor, and computer programs stored on the memory and executable on the processor, wherein the computer programs, when executed by the processor, implement the model training method according to claim 1.

23. (canceled)
